(19) United States
(12) Patent Application Publication
(10) Pub. No.: US 2019/0019128 A1
(43) Pub. Date: Jan. 17, 2019

(54) COMPUTER-IMPLEMENTED SYSTEM AND METHOD FOR MANAGING PILOT CAR ESCORTS FOR OVERSIZED CARGO GROUND SHIPPING

(71) Applicant: USAOversized.com, LLC, Billings, MT (US)

(72) Inventors: Kenneth R. Fox, JR., Billings, MT (US); Kenneth Henkes, Deland, FL (US); Michael Preston, Milpitas, CA (US)

(21) Appl. No.: 15/649,353

(22) Filed: Jul. 13, 2017

(51) Int. Cl. G06Q 10/06

(52) U.S. Cl. CPC G06Q 10/06313; G06Q 10/083

(57) ABSTRACT

A computer-implemented system for managing pilot car escorts for oversized cargo ground shipping with one or more servers upon which are hosted a registration module, a pilot car audit module, and a vetting module. The pilot car client computer synchronously sends pilot car registration information to the server to initiate the automated audit process, and the server synchronously returns audit results to the pilot car client computer. The dispatch client computer synchronously sends load contract selection information to the server, and the server synchronously returns to the dispatch client computer a list of pilot cars that meet selection filter criteria. The system also includes a pilot car mobile device that is configured to enable tracking of pilot cars.

### BACKGROUND OF THE INVENTION

### 1. Field of the Invention

The present invention relates generally to the field of oversized cargo ground shipping, and more particularly, to a computer-implemented system and method for managing pilot car escorts for oversized cargo ground shipping.

### 2. Description of the Related Art

The pilot car industry today is managed in large part by a number of smaller pilot car brokers, which are unregulated by any form of government entity and not required to be bonded. These brokers maintain their own lists of available pilot car escorts. When a job comes in, they typically contact the pilot car operators via phone to determine who is available for a given job. Records are kept on paper, and often there is no verification of an operator's qualifications, such as experience, insurance coverage, vehicle condition, equipment, etc. In fact, until the present invention, no one had fully automated management of the pilot car industry, from the time a request is made by a trucking company for a pilot car escort to payment of the pilot car operators, including all of the logistics in between.

Current systems, which are entirely manual, require a dispatcher to contact all of the pilot cars on his or her list to determine where those cars are located and which cars are closest geographically to the job. The existing system results in enormous inefficiencies due to the lack of geographic coordination among vehicles. When a pilot car operator is vetted, the vetting process can take hours and is often incomplete. For example, typical insurance declarations pages might indicate how much insurance an operator has but not whether those insurance limits are sufficient under state law. There is currently no process for determining whether a pilot car operator has the necessary experience and/or equipment for a given job, nor is there any way for a trucking company to ascertain whether an operator meets state regulatory requirements for vehicle wheelbase, weight or type. Sometimes a trucking company will not learn that a pilot car or pilot car operator is lacking in one of these areas until the operator shows up for the job, at which point it may take hours to find a replacement. In the trucking industry, where time is money, these kinds of errors and miscommunications significantly and adversely affect a trucking company's bottom line. Furthermore, the failure to use qualified pilot cars and pilot car operators can lead to significant fines being imposed upon the trucking company by the U.S. Department of Transportation and/or the cancellation of transport permits issued to the trucking company. In short, the current system for dispatching and managing pilot cars is haphazard and largely dysfunctional.

What is needed is an automated system for managing the pilot car industry that immediately locates available pilot cars nearest to the job, vets pilot car operators across a number of different parameters, negotiates the load contracts with the trucking companies, makes payments to the pilot car operators, and invoices the trucking company, all virtually instantaneously. The present invention not only increases economic efficiencies, but it also improves safety on the road by ensuring that only qualified pilot car operators are hired.

Some inroads have been made into automating the logistics associated with the transportation industry in general; however, none of these systems is specific to the pilot car industry, and none of them incorporates all of the modules and functionality of the present invention. For example, U.S. Pat. No. 6,807,481 (Gastelum, 2004) discloses a logging and compliance computer system for use by drivers in meeting regulations when driving a vehicle containing a cargo. The system maintains data regarding a driver's recent driving history, and it allows the driver to enter data concerning the driver's destination, equipment safety report, and cargo description. The system then plots a route to the destination for the driver taking into consideration the data that has been inputted. The system also provides warnings to the drive when it is time to rest. This system is not specific to pilot cars, does not identify the location of multiple vehicles on a single screen, and does not have the ability to vet multiple drivers instantaneously, nor does it include any accounting or invoicing functions.

U.S. Pat. No. 7,409,356 (Geddes et al., 2008) involves supply chain management generally. The invention incorporates a transportation management module that helps plan, schedule and track the delivery of goods or services to customers; this module maintains records of where the goods are located and where their final destination will be and plans delivery accordingly. The invention combines asset tracking, which is used in many different applications, with route planning, similar to what is described in Gastelum above. The present invention does not involve route planning. Rather, in the present invention, the trucking company provides the route, and the present invention locates, contacts, vets, hires and pays the pilot car escorts in accordance with applicable laws and regulations so that the trucking companies are not exposed to potential fines and/or loss of licenses.

U.S. Pat. No. 8,428,870 (Berry, 2013), U.S. Patent Application Pub. No. 20120171006 (Berry), and U.S. Patent Application Pub. No. 20120179624 (Berry) all describe a system and method for fabrication and assembly of large-scale modules remote from a heavy industrial hydrocarbon processing plant site, including overland transportation of the modules to the plant site. In the context of this particular invention, the term “module” means a large, physical container such as a railcar module or standard truck module. The transportation logistics system comprises a database accessible by a server and containing heavy-haul transportation logistics information, as well as a mobile first client computer that is configured to provide real-time updating of the database with regard to land routes suitable for heavy-haul transportation. As with the two inventions previously described, the transportation aspect of this invention relates primarily to route planning. As noted above, the present invention does not involve route planning but rather the management of pilot car escorts for oversized cargo ground shipping—a problem that no prior art system has yet endeavored to solve.

U.S. Patent Application Pub. No. 20090157461 (Wright et al., 2009) discloses a vehicle deployment planning method and system for planning a convoy that travels on a roadway. This invention locates available vehicles for the convoy and displays those available vehicles in a vehicle corral. The user then selects one or more vehicles from the vehicle corral and places them in a position in the convoy. The invention determines whether the convoy configuration is complete, and if so, displays the complete convoy configuration. This invention is nothing more than an asset location and configuration system; it does not provide any of the functionality of the present invention as it relates to the hiring, vetting and payment of pilot car escorts.

U.S. Patent Application Pub. No. 20140129274 (Lluberes et al., 2014) describes a system and method for security escort assignment and monitoring. The system enables a dispatcher to plan a mission, assign assets (security escorts) to the mission, the monitor a virtual representation of the mission as it occurs. The system primarily involves asset tracking, which is not an aspect of the present invention. It also allows a user to assign escort assets to one or more target assets, assign characteristics and properties to the assets, assign a formation to the assets, and assign a route along which the formation of the assets is to travel during a mission. The system generates alerts when an assert deviates from an assigned property, formation or route during a mission.

U.S. Patent Application Pub. No. 20170148313 (Zografos) provides a mobile software application for tracking drayage driver and vehicle movement and providing reports as to driver location and other driver and cargo details in order to facilitate efficient container transport. Data is made available to port terminals, the shipping company, and the destination warehouse. The system links cargo owners, shippers, terminal yards, drayage companies, drivers and drayage job assignment. The focus of this invention is on transporting a container from one location to another in the most efficient manner possible by eliminating wait times (which is accomplished in part by tracking vehicles). The focus of the present invention is not on the transportation of cargo per se but rather the hiring, vetting, management and payment of pilot car escorts to accompany oversized cargo loads in order to avoid delays, tines and revocation of licenses and to improve safety on the road. The present invention incorporates additional functionality, such as invoicing and accounting modules, as described more fully below.

### BRIEF SUMMARY OF THE INVENTION

The present invention is a computer-implemented system for managing pilot car escorts for oversized cargo ground shipping comprising: one or more servers upon which are hosted a registration module that is configured to accept registrations by trucking companies, pilot car companies, and dispatch companies, a pilot car audit module that is configured to determine via an automated audit process whether state regulatory requirements are met by a pilot car company for selected states of operation, and a vetting module that is configured to determine via an automated vetting process whether the pilot car company possesses commercial auto insurance, general liability insurance, and professional liability insurance; a pilot car client computer that is configured to provide access to a browser, wherein the pilot car client computer synchronously sends pilot car registration information to the server to initiate the automated audit process, and wherein the server synchronously returns audit results to the pilot car client computer; a dispatch client computer that is configured to provide access to a browser, wherein the dispatch client computer synchronously sends load contract selection information to the server, and wherein the server synchronously returns to the dispatch client computer a list of pilot cars that meet selection filter criteria; and a pilot car mobile device that is configured to enable tracking of pilot cars by the system.

In a preferred embodiment, the one or more servers are further configured to host a load contract management module; wherein the load contract management module is configured to assign available load contracts to a load board module or a dispatch module; wherein the system is configured to send email notifications to all registered pilot cars when an available load contract is posted to the load board module; wherein the system is configured to enable a pilot car client to submit a load contract application; wherein the system is further configured to enable a dispatch client to review and accept or decline the load contract application; wherein the system is configured to create automatically a load contract between the dispatch client and an accepted pilot car client; and wherein the system is configured to enable a trucking company client to accept or decline the load contract. Preferably, the one or more servers are further configured to host a pilot car contract management module, and the pilot car contract management module is configured to enable a pilot car company to view details of the load contract and to end the load contract.

In a preferred embodiment, the one or more servers are further configured to host an end load contract module; wherein the end load contract module is configured to enable the pilot car client to provide load contract trip data, load contract trip miscellaneous charges, and graphical signatures for the load contract; and wherein the system further comprises a database that creates automatically a trucking company invoice upon completion of the load contract and sends the trucking company invoice to an invoice approval module. Preferably, the invoice approval module is configured to enable the trucking company client to approve or disapprove the trucking company invoice and to send the trucking company invoice to an invoice dispute module if the trucking company invoice is disapproved by the trucking company client.

In a preferred embodiment, the database also creates a dispatch client invoice that reflects charges from the dispatch client to a system administrator and a pilot car client invoice that reflects charges from the pilot car client to the system administrator, and the system is configured to pay automatically the dispatch client invoice and the pilot car client invoice. Preferably, the dispatch module is configured to select a load contract and to generate an interactive map using pilot car tracking information to display only those pilot cars that qualify for the load contract, and the dispatch module is configured to initiate a load contract offer to one or more qualified pilot car clients.

In a preferred embodiment, the one or more servers are further configured to host a subcontractor pilot car client insurance module, and when a pilot car company fails the vetting module, the system is configured to enable the failed pilot car company to be treated as a subcontractor pilot car via the subcontractor pilot car client insurance module. Preferably, the one or more servers are further configured to host an additional pilot car client qualifications module; wherein the additional pilot car client qualifications module is configured to enable a trucking company client to enter additional pilot car qualifications; and wherein the additional pilot car client qualifications module filters registered pilot car companies against the additional pilot car qualifications entered by the trucking company and removes non-qualifying pilot car companies from pilot car selection.

In a preferred embodiment, the server is configured to send email messages of document expirations to pilot car accounts, load contract verifications to trucking company client accounts, load contract rate offers to pilot car company accounts, load board load contract alerts to registered and available pilot car company accounts, invoice approvals to trucking company client accounts, invoice disputes to trucking company client and pilot car company accounts, and past due invoices to trucking company client accounts.

### BRIEF DESCRIPTION OF THE DRAWINGS

FIG. 1 is a system architecture diagram of the present invention.

FIG. 2 is a screenshot of the client view of the administrative registered users manager module.

FIG. 3 is a flow diagram of the client registration process.

FIG. 4A is a screenshot of the registration module for the registration of pilot car companies.

FIG. 4B is a continuation of the screenshot of the registration module for the registration of pilot car companies.

FIG. 4C is a continuation of the screenshot of the registration module for the registration of pilot car companies.

FIG. 4D is a continuation of the screenshot of the registration module for the registration of pilot car companies.

FIG. 4E is a continuation of the screenshot of the registration module for the registration of pilot car companies.

FIG. 5A is a screenshot of the registration module for the registration of dispatch companies.

FIG. 5B is a continuation of the screenshot of the registration module for the registration of dispatch companies.

FIG. 5C is a continuation of the screenshot of the registration module for the registration of dispatch companies.

FIG. 6A is a screenshot of the registration module for the registration of trucking company clients.

FIG. 6B is a continuation of the screenshot of the registration module for the registration of trucking company clients.

FIG. 6C is a continuation of the screenshot of the registration module for the registration of trucking company clients.

FIG. 6D is a screenshot of a web-based email client illustrating the system administrator email information of a trucking company client credit application.

FIG. 7 is a flow diagram of the trucking company client additional pilot car client qualifications.

FIG. 8A is a screenshot of the trucking company client account setup form.

FIG. 8B is a continuation of the screenshot of the trucking company client account setup form.

FIG. 8C is a continuation of the screenshot of the trucking company client account setup form.

FIG. 8D is a screenshot of the trucking company client management module.

FIG. 9 is a flow diagram of the background process for creating a pilot car client account.

FIG. 10 is a flow diagram of the background process for auditing pilot car accounts to meet state regulations.

FIG. 11 is a screenshot of the state regulation audit module.

FIG. 12 is a flow diagram of the client vetting process.

FIG. 13 is a screenshot of the client vetting module.

FIG. 14 is a flow diagram of the software communication system of the present invention.

FIG. 15 is a flow diagram of the load contract data entry form.

FIG. 16A is a screenshot of the load contract detail section of the load contract management module.

FIG. 16B is a continuation of the screenshot of the load contract detail section of the load contract management module.

FIG. 17 is a flow diagram of the load contract management module.

FIG. 18A is a screenshot of the load contract selection section of the load contract management module.

FIG. 18B is a screenshot of the pilot car contract management module.

FIG. 19 is a flow diagram of the load board module.

FIG. 20 is a screenshot of the load board module.

FIG. 21 is a flow diagram of the pilot car client tracking module.

FIG. 22 is a flow diagram of the pilot car selection module.

FIG. 23 is a screenshot of the dispatch management module.

FIG. 24 is a flow diagram of the load contract negotiation module.

FIG. 25 is a screenshot of the load contract negotiation module.

FIG. 26 is a flow diagram of the end load contract module.

FIG. 27A is a screenshot of the end load contract section of the pilot car contract management module.

FIG. 27B is a continuation of the screenshot of the end load contract section of the pilot car contract management module.

FIG. 27C is a continuation of the screenshot of the contract end trip section of the end load contract module.

FIG. 28 is a flow diagram of the invoicing module.

FIG. 29 is a screenshot of a dynamically created contract invoice.

FIG. 30 is the flow diagram of the subcontractor pilot car client insurance module.

FIG. 31 is a screenshot of the subcontractor pilot car client insurance module.

FIG. 32 is a flow diagram of the invoice approval/dispute module.

FIG. 33 is a flow diagram of the accounting module.

FIG. 34 is a screenshot of the invoice management module.

### DETAILED DESCRIPTION OF INVENTION

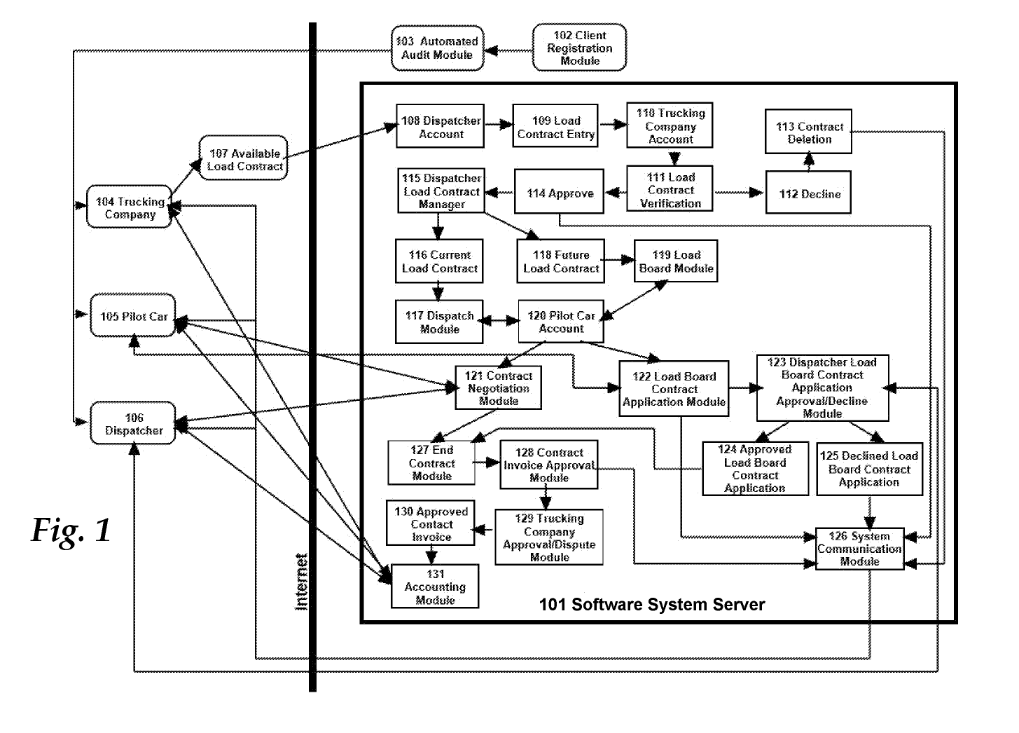

FIG. 1 is a system architecture diagram of the present invention. The system comprises various modules that manage the oversized freight load logistics. All of these modules are hosted on the software system server 101 (which may be comprised of a single or multiple servers). Note that separate servers may be used for hosting the database and/or sending email messages. The process begins with the registration module 102, which allows a user to register and select the type of company the user will be registering. The system uses a credit application form for trucking companies 104, and the registration module accepts registrations by either pilot car companies 105 or dispatch companies 106. When the user selects a pilot car company, the audit automated module 103 is then activated to begin the audit process by making sure that the registering pilot car company meets all state regulations before registration is submitted. (As used herein, the term “pilot car company” may mean an actual business entity or a natural person.)

With the registration complete, the trucking company 104 then uses an available freight load contract 107 to communicate with a registered dispatch company 108 the details of the freight load contract. The registered dispatch company 108 then uses the freight load contract input module 109 to enter the details of the freight load contract into the system. After the freight load contract details are saved to the system, the system communicates with the registered trucking company 110 that the freight load contract information has been entered. The system then uses the communication module 126 to request from the registered trucking company an approval of the freight load contract 111, which the registered trucking company may then approve 114 or decline 112. If the registered trucking company chooses to decline the freight load contract, the system removes the freight load contract information 113 from the database. Otherwise, if the registered trucking company chooses to approve the freight load contract information, the entered freight load will appear as an icon and on a list in the dispatcher load contract management module 115.

The registered dispatch company will also use the load contract management module to determine if the current load contract 116 or future load contract 118 will be dispatched using the freight load contract to available qualified pilot car dispatch module 117 or if it will be posted to the freight load contract board 119 to wait for registered pilot car 120 applications. The registered dispatch company will select a current freight load and available registered pilot car company(ies) from the dispatch module 117 and then use the contract rate negotiation module 121 to negotiate the current load contract agreement. Registered pilot car companies 120 will use the load board module 119 to locate available loads on the system. When the available and qualified registered pilot car company desires a contract with a load contract posted to the load board, the system uses the load contract application module 122 to begin the application process. The registered dispatch company can use the load board module 119 to review the applications for a load contract and use contract application approval module 123 to accept and assign an available and qualified pilot car company. The application approval module will save the status of the approved load contract application 124 and send all other applying pilot car companies notification that the load contract application is no longer available 125. The contract negotiation module 121 is used by both processes of either dispatching a load contract to an available and qualified registered pilot car company or approving and assigning a load contract board application approval 124.

All assigned load contract assignments, whether dispatched or assigned from the load contract board, will remain in a pending status until the pilot car company has escorted the load contract to its destination. When the load contract is complete, the pilot car company will use the end trip module 127 to enter trip information regarding the finalized load contract. The system then will automatically generate invoices using the trip information and the negotiated contract rates and will request approval of the invoice from the trucking company using the contract invoice approval module 128. The registered trucking company will then use the approval or dispute module 129 to set the status of the contract invoice. The approved contract invoice 130 will then be available in the company accounting module 131, or a dispute and resolution process will be initiated until the invoice is approved.

Scripting code on the browser on the client computer synchronously sends registration information to the server 101 to initiate the automated audit process. (As used herein, “client browser” means a browser on the client computer.) Compiled code on the server receives the registration information to compare, along with selected states of operation, against state regulation data that is stored in a database on the server. The server returns to the client browser information regarding the outcome of the state regulation audit process.

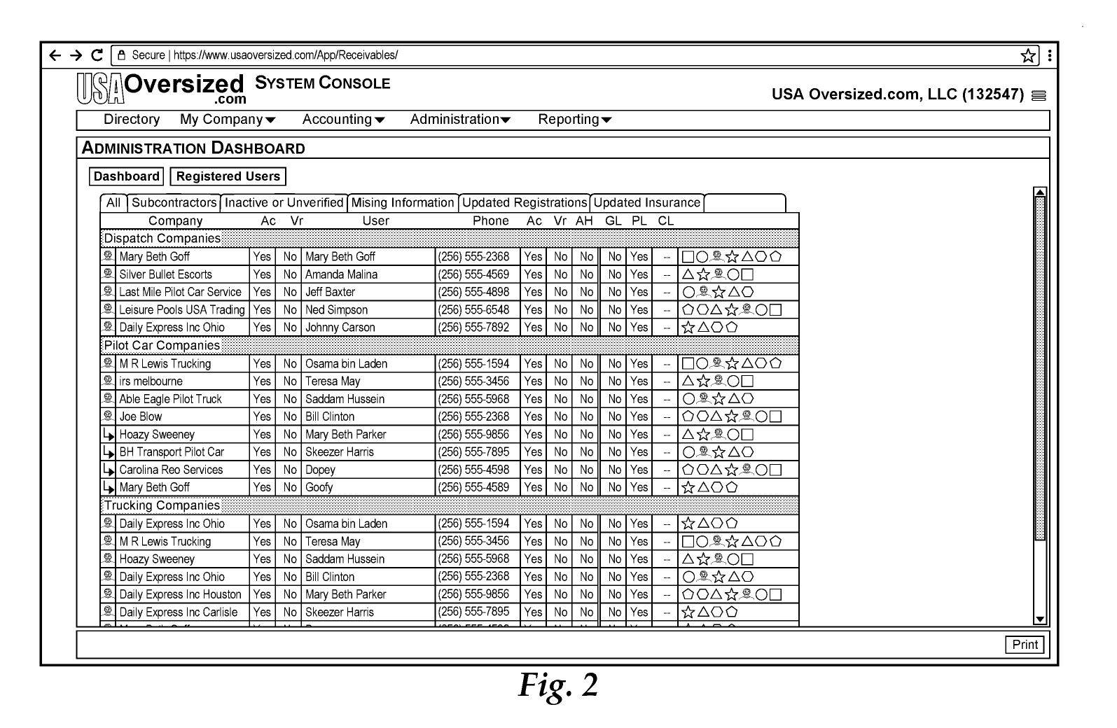

FIG. 2 is a screenshot of the client view of the administrative registered users manager module. This module is used to managed registered dispatch, pilot car, and trucking companies on the system. From this module, an administrative user may make notes, perform verifications, validate, impersonate, and select pilot car company subcontractors. This screen is also broken down into tabs for easy filtering between all registered companies, just registered pilot car company subcontractors, inactive or unverified registered companies, registered companies with missing required information, registered companies with recent information updates, registered companies with recent insurance updates, and registered pilot car companies that have completed and validated registrations and are qualified to be dispatched by registered dispatch companies.

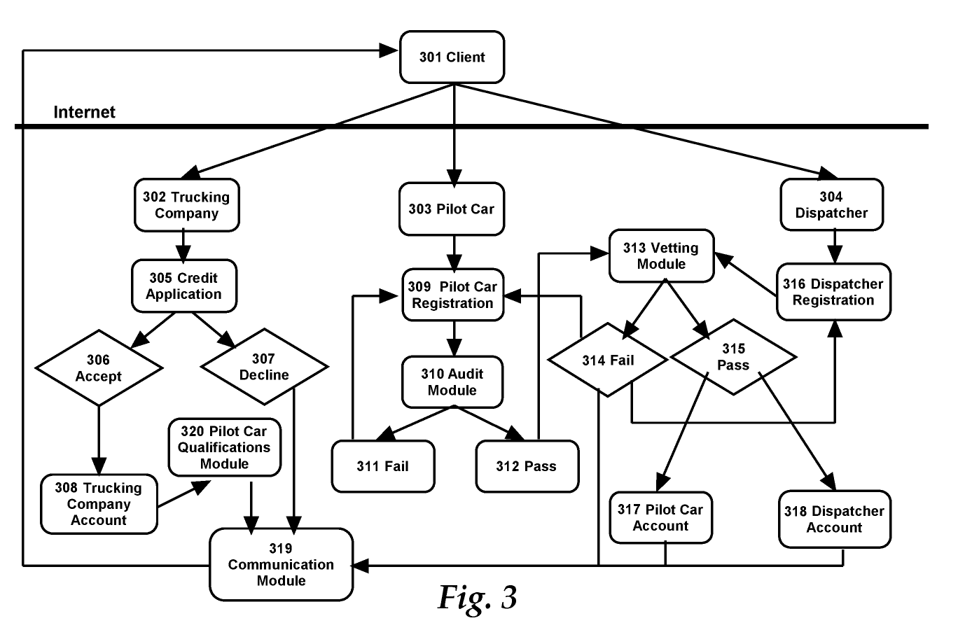

FIG. 3 is a flow diagram of the client registration process. When a trucking company 302, dispatch company 304 or pilot car company 303 client elects to register, a determination is made as to which registration criteria to present. Trucking company criteria presents to the client 301 credit application 305 requirement information. Once completed, the trucking company credit application information is then composed in an email message and sent through the communication module 319 to the system administrator account. A system administrator then reviews the trucking company credit application information and chooses either to accept 306 or decline 307. The system administrator registers the accepted trucking company and completes any additional pilot car qualifications 320 to create the trucking company account 308. An email message is composed to inform the applying trucking company that the trucking company account is created or that the credit application information is declined and is sent through the communication module.

Pilot car company and dispatch company criteria presents to the client a form 309 and 316 in which to provide necessary registration information. Before registration is complete, the pilot car registration information is synchronously sent to the pilot car automated audit module 310 to verify that all state regulations have been satisfied. If the pilot car automated audit fails 311, a message is reported to the registering pilot car client and returns control to the pilot car registration. Upon registration completion, an inactive and unverified dispatch company account 318 is created pending final verification through the vetting module 313. If the pilot car automated audit passes 312, the inactive and unverified pilot car company account 317 is created pending further verification through the vetting module. An email message is composed when the vetting fails 314 and is sent through the communication module to the registered pilot car or dispatch company on a cycle that repeats until the pilot car or dispatch company registration vetting passes 315.

During the registration process, certain documents are required to be uploaded. Scripting code on the client browser allows for the documents to be uploaded and sends the document upload information synchronously to the server for processing. Compiled code on the server receives the upload document information and creates a temporary location for the uploaded document.

When the registration has passed, the state regulation and required data verification scripting on the client browser sends the form data containing the registration information to the server for process completion. Compiled code on the server creates the necessary data records, specifically, a company- and site administrator-specific directory structure on the server for storing registration uploaded documents. When the compiled code creates the directory structure, all files uploaded to a temporary location are moved to the created directory structure for permanent storage. The compiled code on the server returns a success or failure outcome to the client browser. The client browser then reports the outcome including the unique company ID of the successful registration.

Scripting modules on the client browser make the determination to display registration criteria based on the selected type of registration, and compiled code on the server makes the determination as to how the inputted registration information is processed. Specifically, the compiled code on the server composes the trucking company credit application registration information in an email message and sends it to the system administrator for review. The compiled code on the server saves the dispatcher and pilot car registration information to the database.

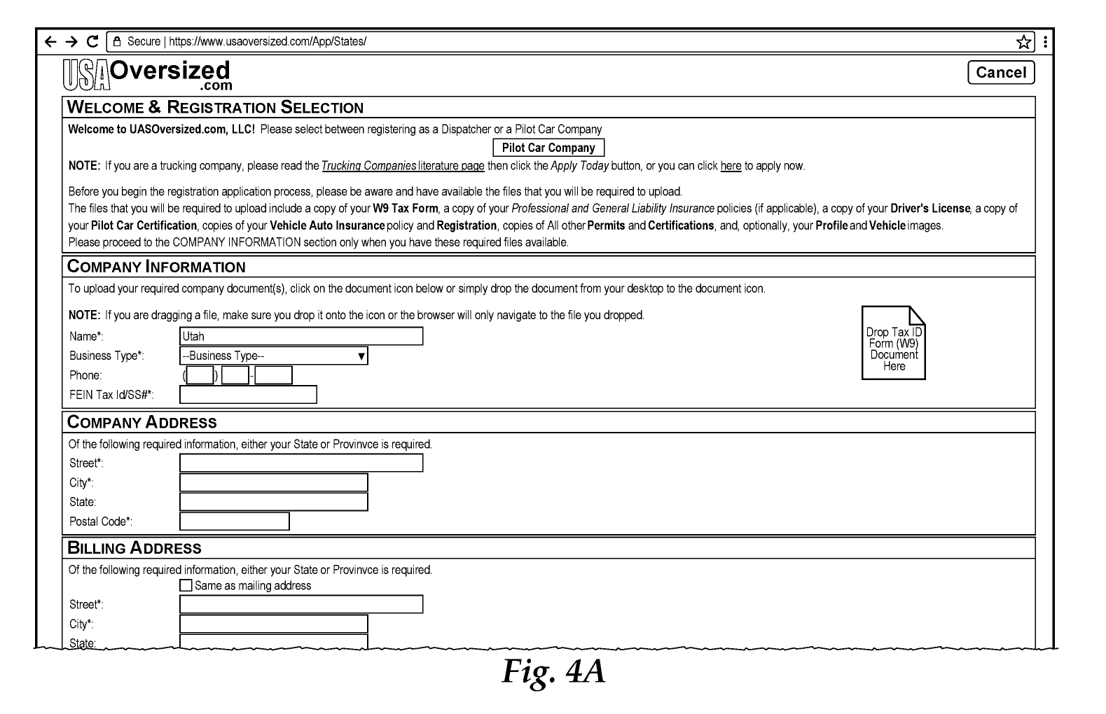

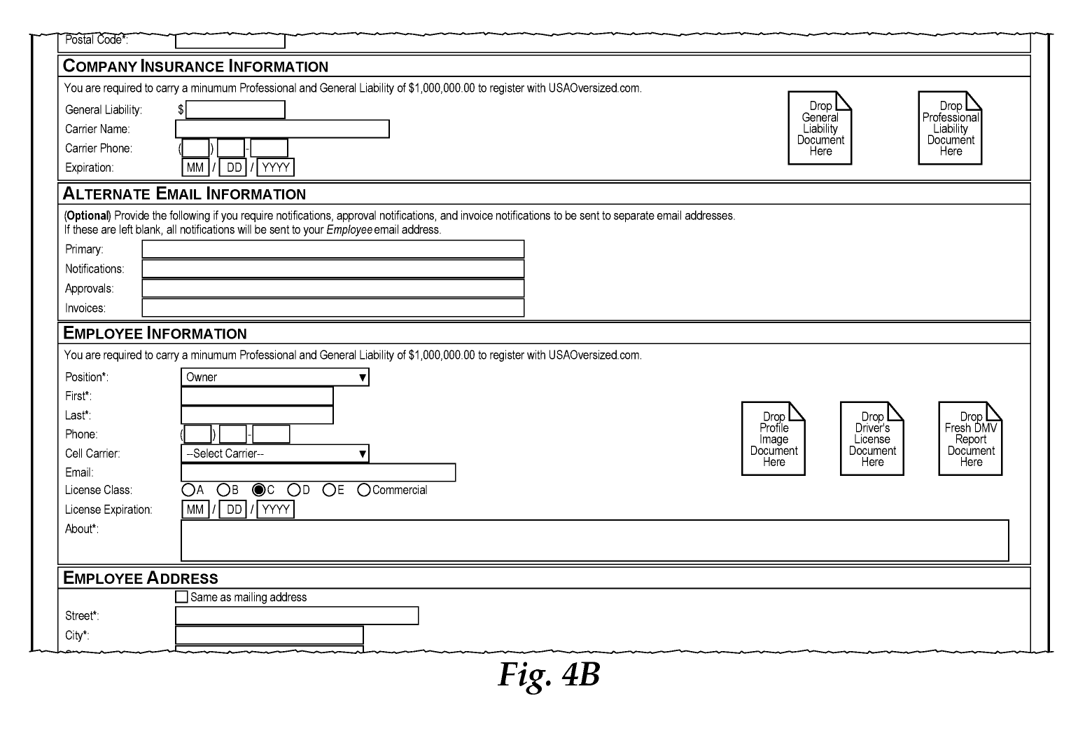

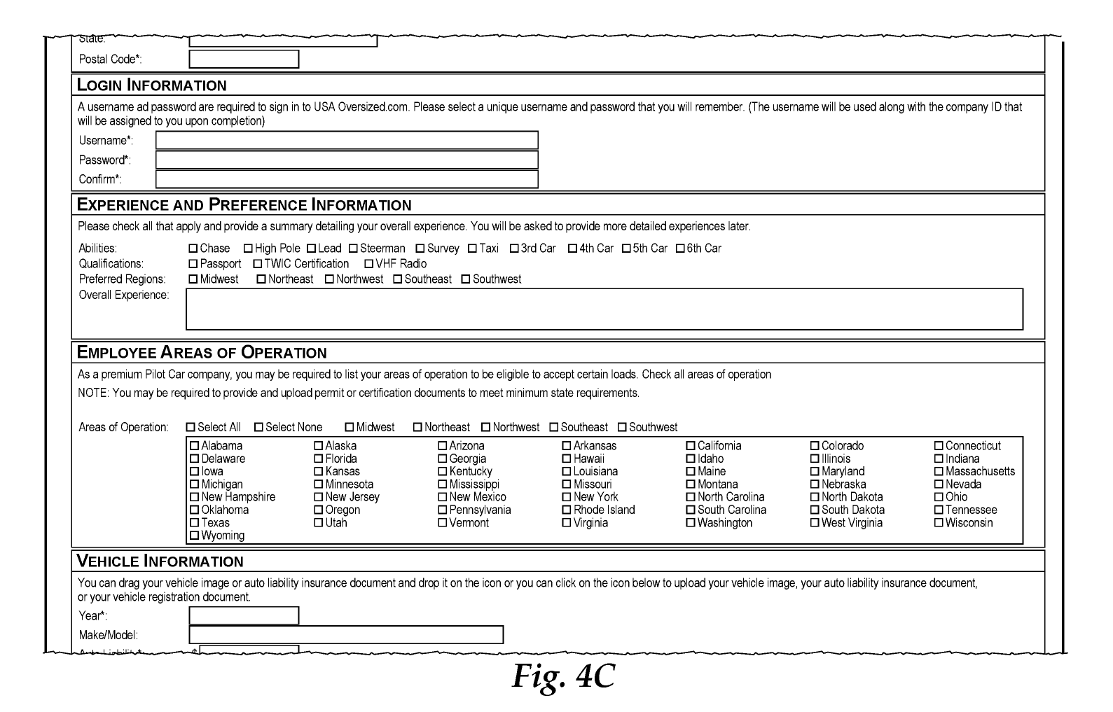

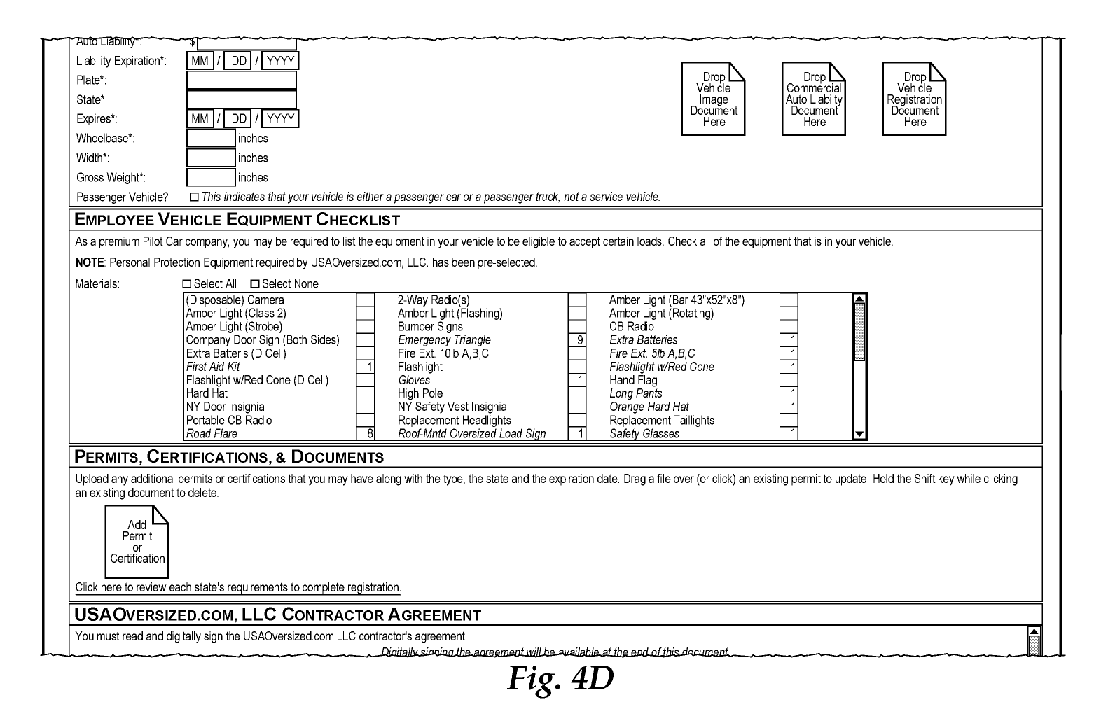

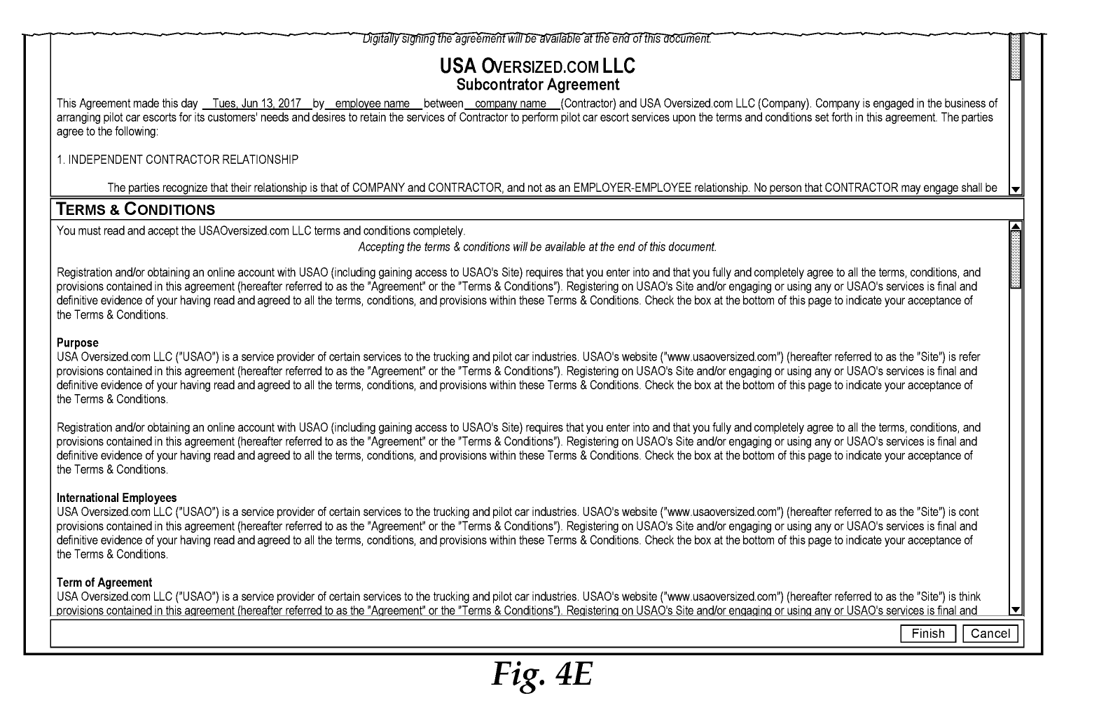

FIGS. 4A-4E are screenshots of the registration module for the registration of pilot car companies. This module contains an input form for accepting required information to complete the registration process that is different from the registration form for registering dispatch companies and registering trucking company clients. The input form dynamically shows or hides certain fields depending on other selected criteria.

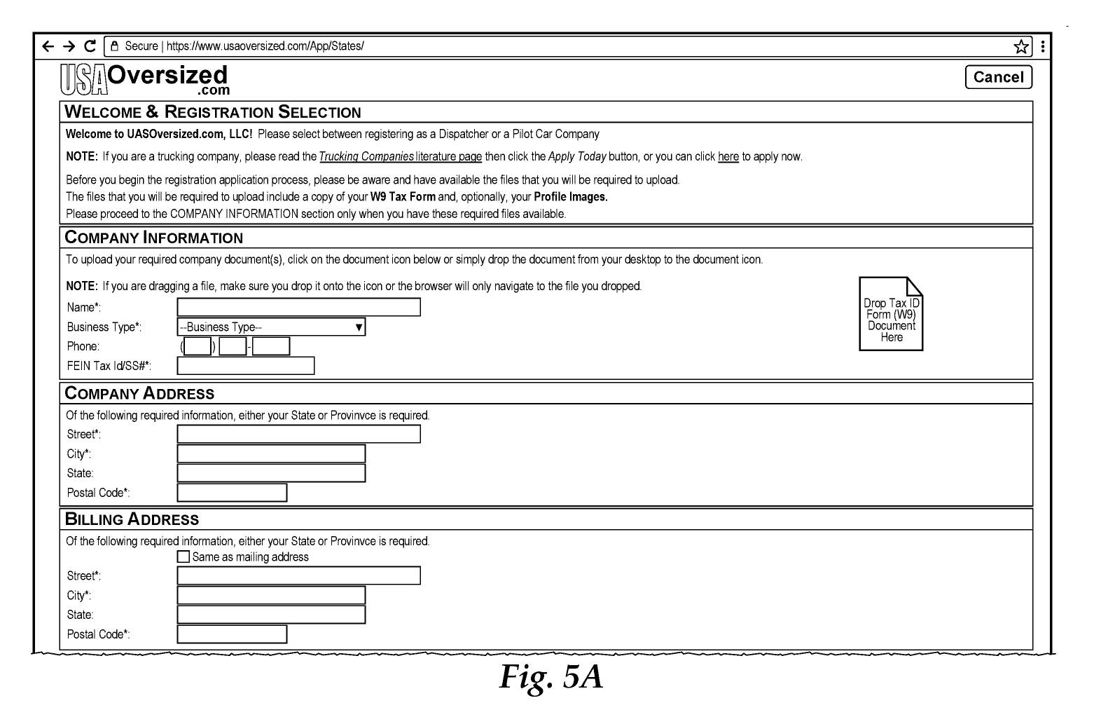

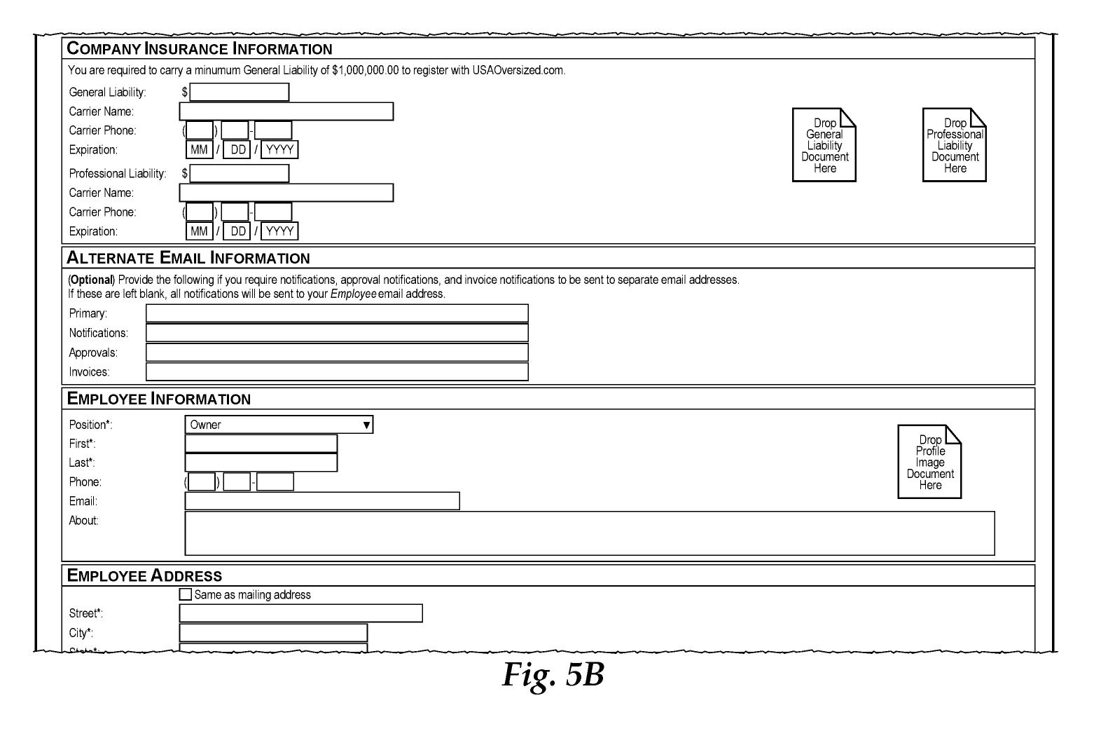

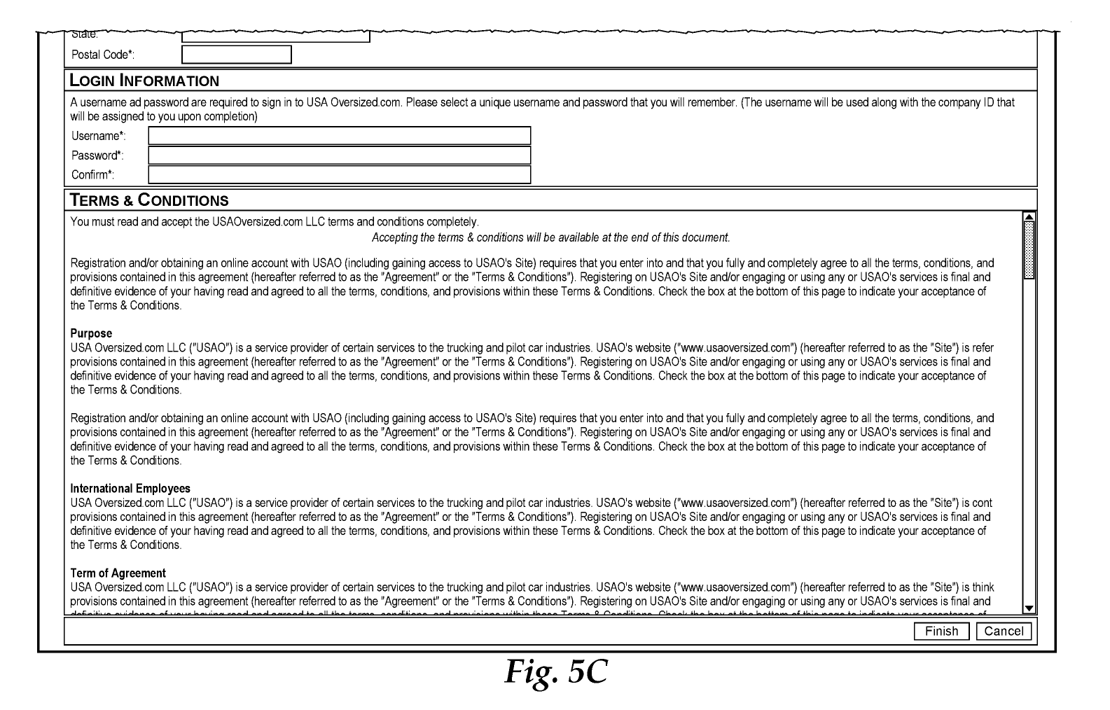

FIGS. 5A-5C are screenshots of the registration module for the registration of dispatch companies. This module contains an input form for accepting required information to complete the registration that is different from the registration form for registering pilot car companies and registering trucking company clients.

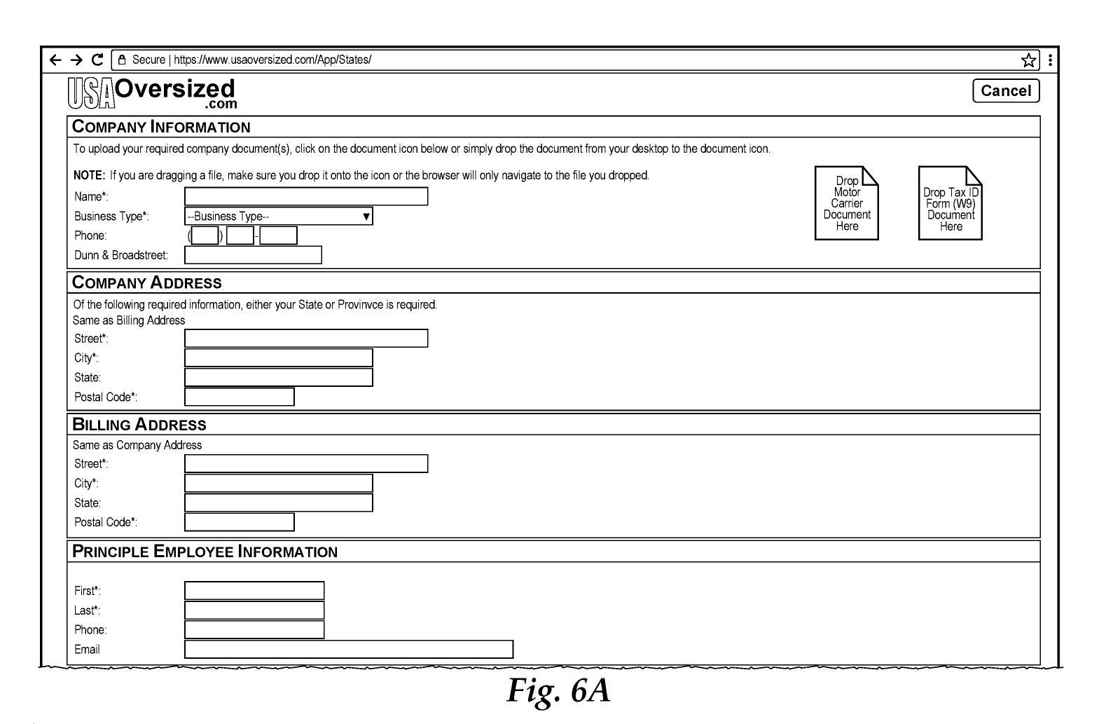

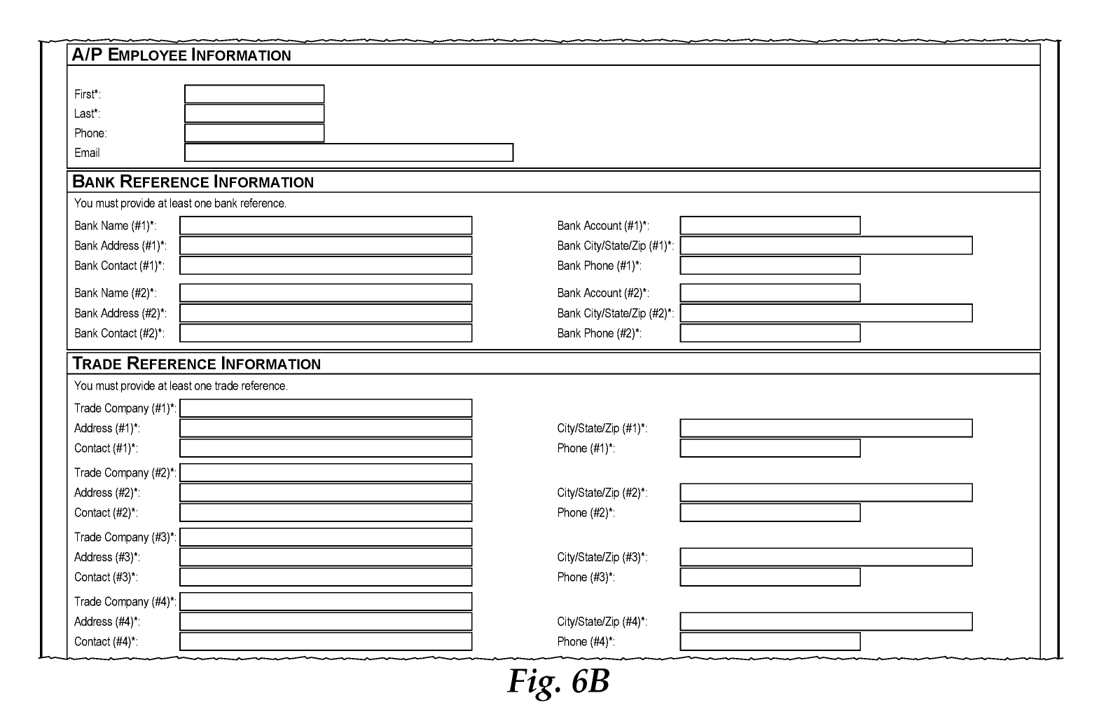

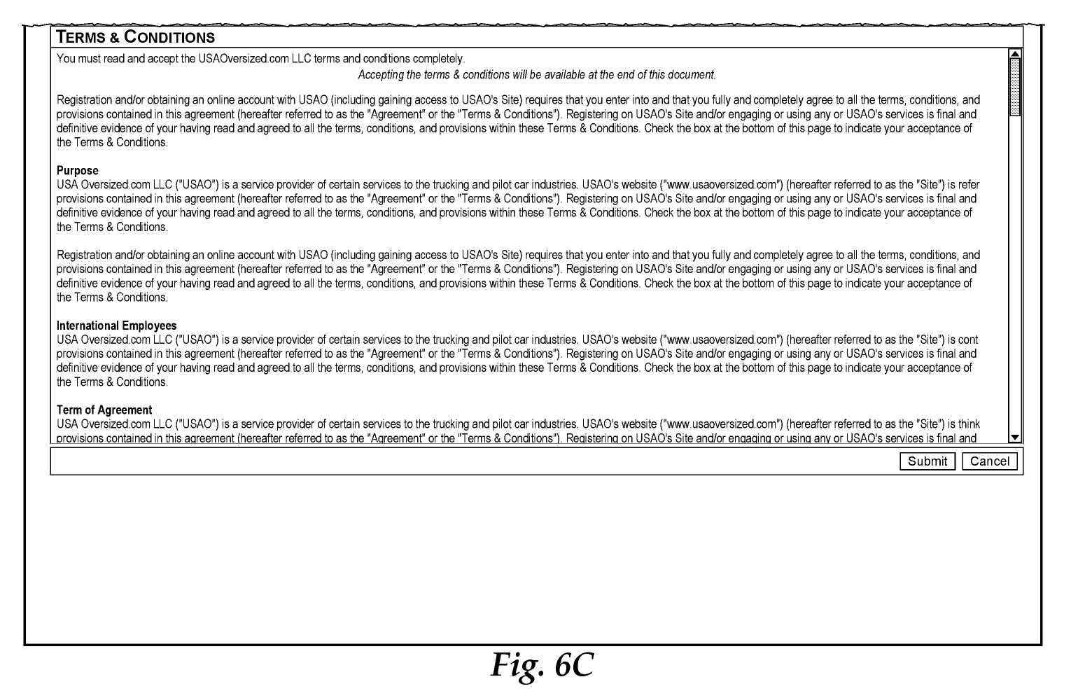

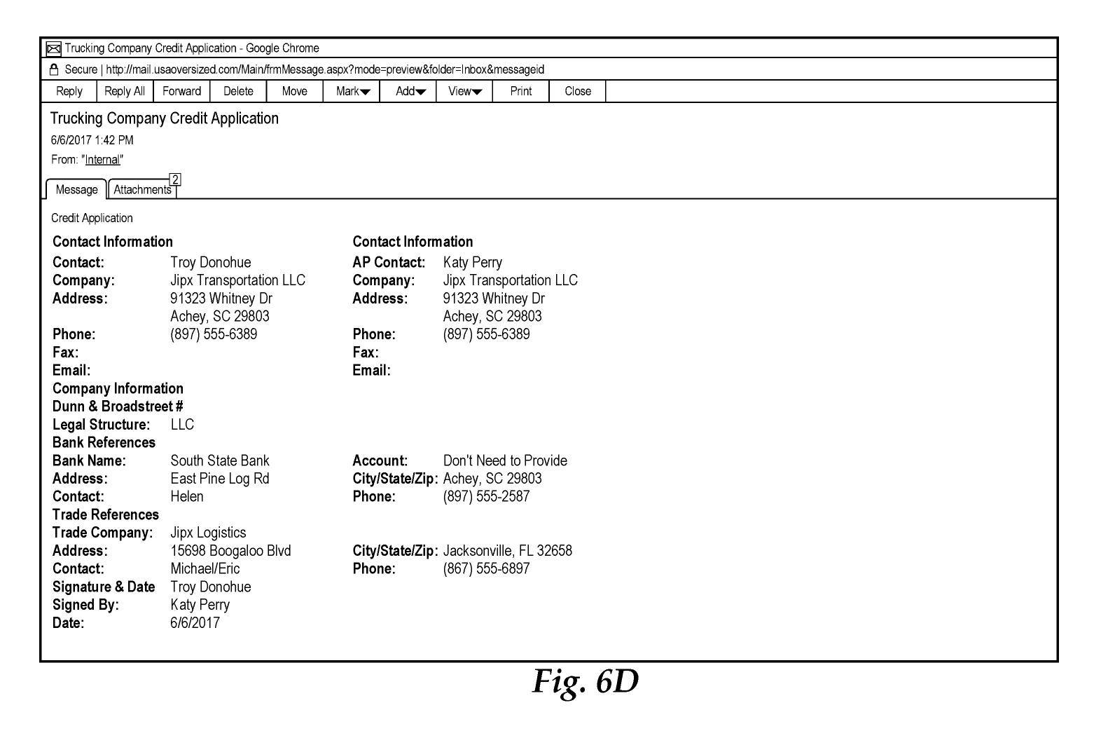

FIGS. 6A-6C are screenshots of the registration module for the registration of trucking company clients. This module contains an input form for accepting required information to complete the registration process that is different from the registration form for registering pilot car companies and registering dispatch companies. The trucking company client registration process sends the registration information to a system administrator email (see FIG. 6D) for the application of trucking company client credit considerations.

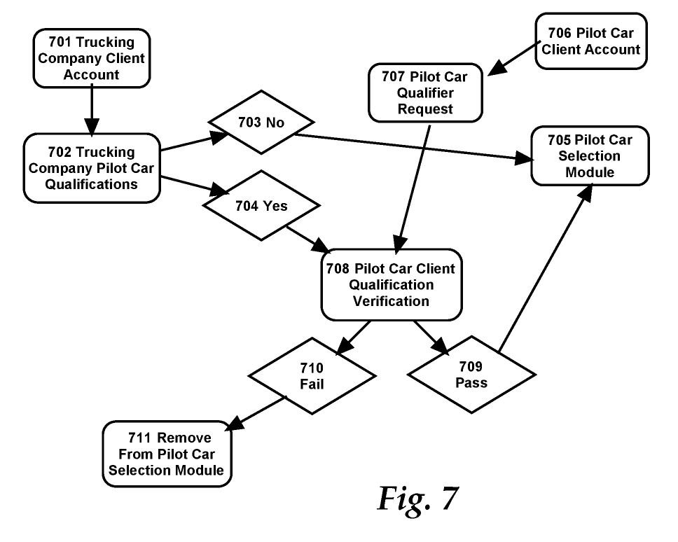

FIG. 7 is a flow diagram of the trucking company client additional pilot car client qualifications. A trucking company client 701 uses this module to enter any additional pilot car qualifications 702. If no additional pilot car qualifications are needed 703, the pilot car selection module 705 skips the check for additional client pilot car qualifications. If additional pilot car qualifications are added 704, then the pilot car selection module uses the trucking company client additional pilot car requirements 707 to filter pilot cars for only those pilot cars that pass the qualification verification 708. Pilot cars that meet the additional client pilot car requirements pass 709 in the pilot car selection module. Pilot cars that do not meet the additional pilot car requirements fail 710 and are removed from the pilot car selection 711.

Registered pilot car clients 706 request to qualify 707 for the additional pilot car qualifications that are used in the pilot car selection process. Pilot cars that have not qualified for the trucking company client additional pilot car qualifications will not pass the pilot car selection process for any load contracts provided by that trucking company client.

Scripting modules on the client browser send load contract selection information to the server. Compiled code on the server compares available registered pilot car account and selected load contract information against trucking company client pilot car qualifications, pilot car company qualifiers, recorded GPS position age (i.e., when the GPS position was last saved to the database), pilot car account activation and verification status, and load contract pilot car requirement information in the database. Only pilot car accounts that meet the selection criteria stipulated by the trucking company client additional pilot car qualifications and the load contract pilot car requirements are added to a list returned to the dispatch client browser for selection.

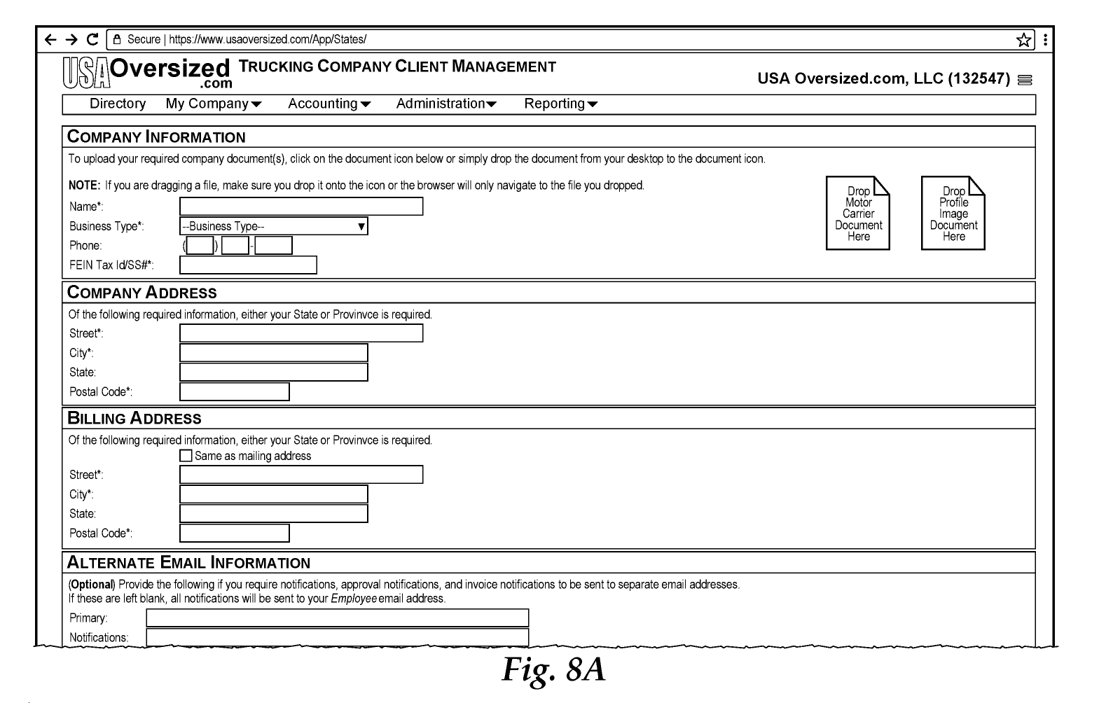

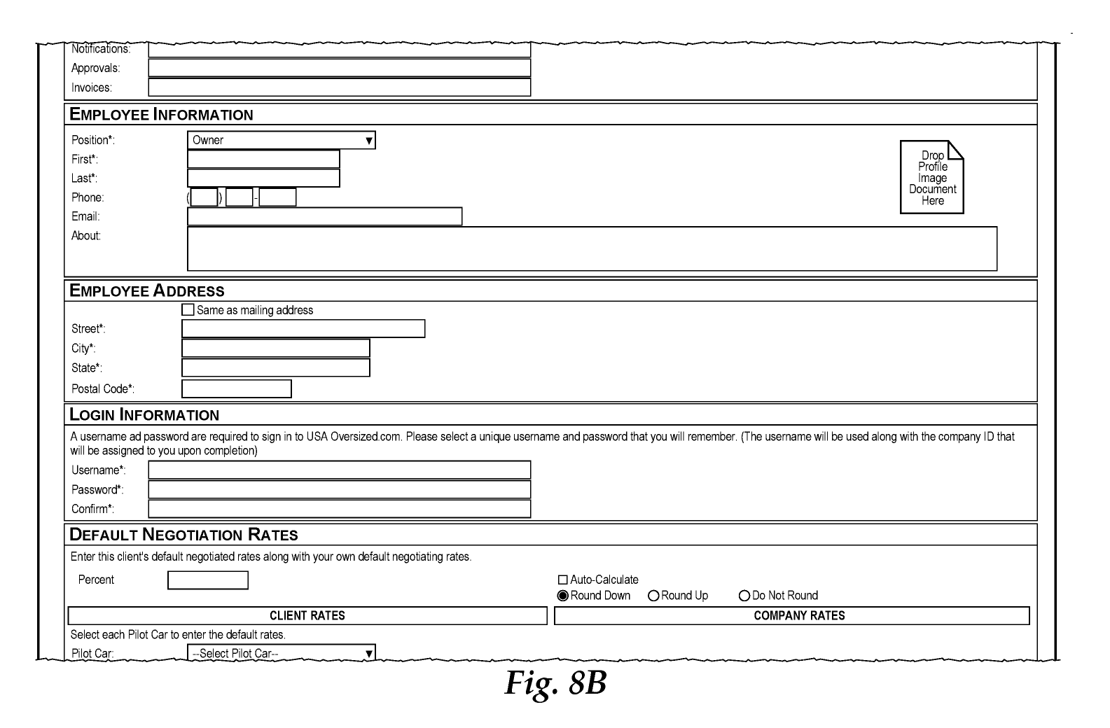

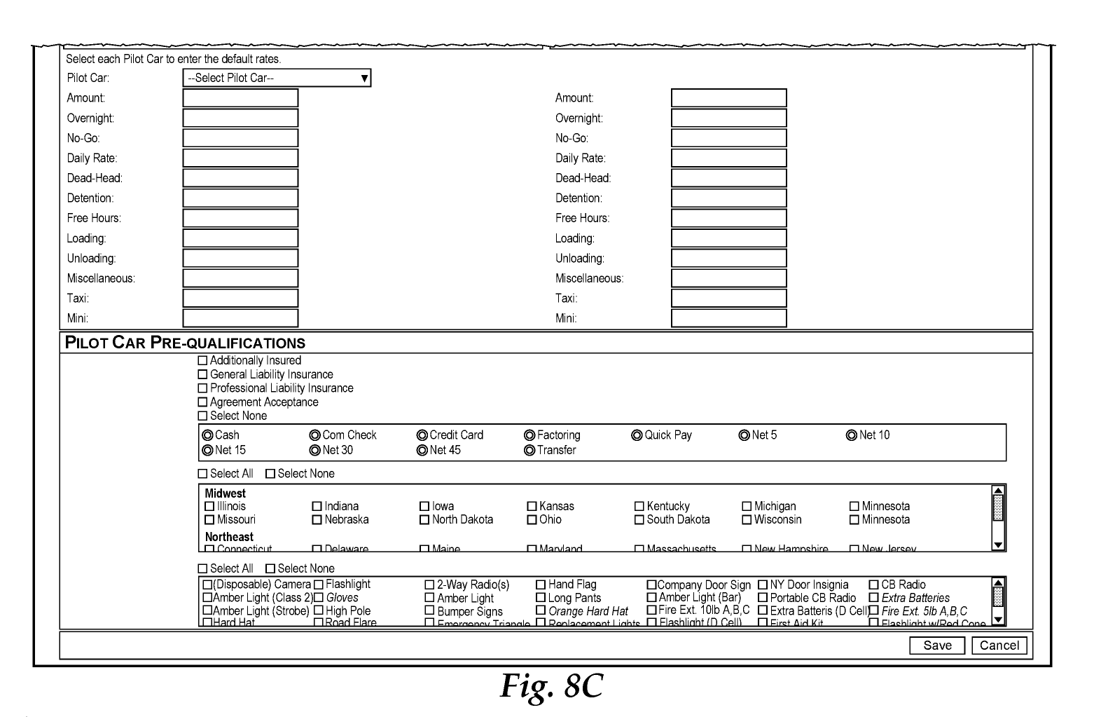

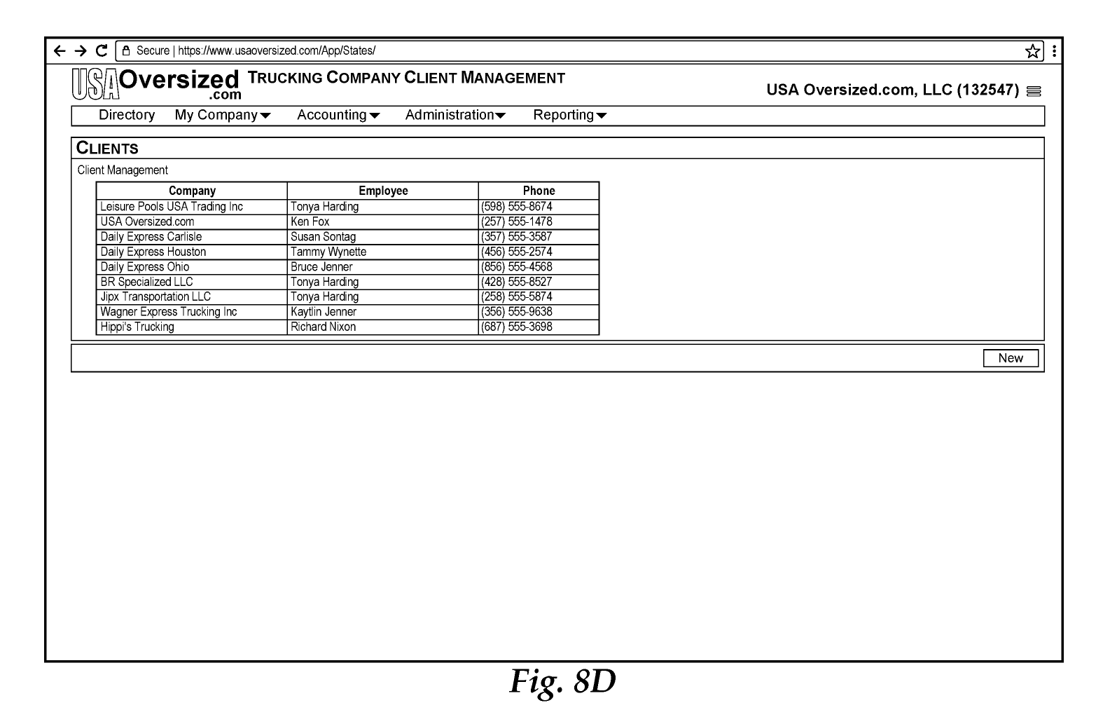

FIGS. 8A-8C are screenshots of the trucking company client account setup form. A system administrator uses the software system trucking company client management module (see FIG. 8D) to complete the registrations of and to modify the registration information of approved trucking company clients.

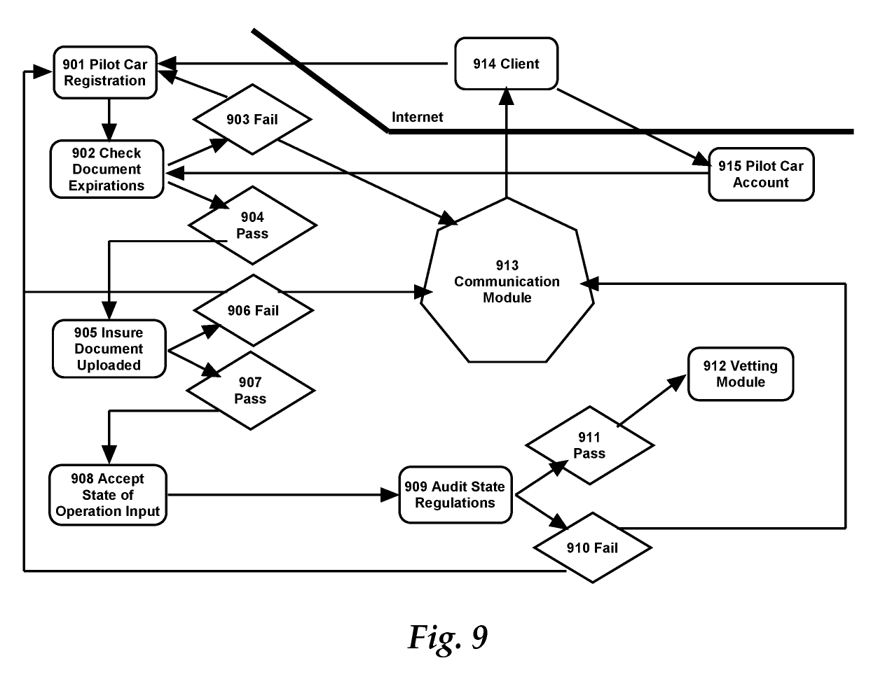

FIG. 9 is a flow diagram of the background process for creating a pilot car client account. The automated audit module begins with pilot car registration 901 from the client 914. During the registration input process, the system checks for document expirations 902, required document upload 905 information, and state regulation 909 requirements. The registering pilot car company will select states of operation 908 during registration that will be verified against state regulations in the system database.

If document expiration dates are not valid 909 or required documents have not been uploaded 906 or state regulations have not been met 910, the system reports back to the client, and registration completion is prevented. If document expiration dates are valid 904 and all required documents have been uploaded 907 and all state regulations have been satisfied 911, the pilot car account is created with a status of inactive and unverified and moves to the vetting module 912. Registration cannot be complete while any of the document expiration dates are not valid 903. The automated audit continues to validate the pilot car account 915 throughout the lifetime of the account to ensure that all requirements and regulations are met. The automated audit module uses the communication module 913 to compose and send messages to the pilot car company regarding the status of their audit.

Scripting code on the client browser synchronously sends registration data to the server to initiate the audit process. Compiled code on the server receives pilot car registration information, including selected states of operation, and then compares the pilot car registration information against state regulation information in the database on the server to ensure that state regulations are being met. The server then returns the results of the initial audit synchronously to the client browser.

The compiled code on the server, in conjunction with stored procedures in the system database, compares pilot car registration information against audit criteria including registration selected states of operation. When the audit passes, the pilot car account remains active and available for dispatch. When the audit fails, the pilot car account is deactivated and is not available for dispatch until the audit criteria are met. If an audit failure consists of a document expiration, the compiled code on the server composes an email message of the documents and expiration and uses the communication module to send the notification to the registered pilot car company.

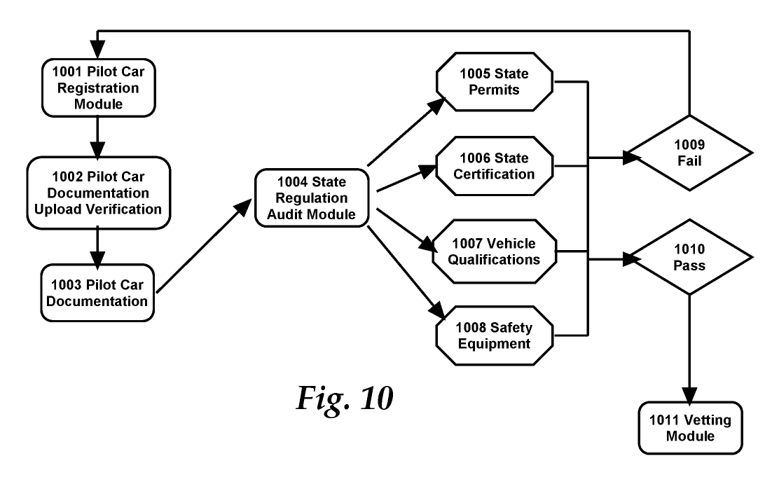

FIG. 10 is a flow diagram of the background process for auditing pilot car accounts to meet state regulations. During the registration of the pilot car 1001, the user uploads required documents 1002, 1003 and enters required information to designate the states in which the pilot car company will operate. The client browser then synchronously passes state and document information to the server application state regulation audit module 1004. The compiled code on the server application then verifies required state permits 1005, certifications 1006, vehicle qualifications 1007, and safety equipment 1008. If the state regulations module verification fails 1009, the server application then returns detailed information to the client browser to be displayed to the user. If the state regulation module verification passes 1010, the registration process is completed, and the server application returns successful registration information to the client browser to be displayed to the user. The pilot car company registration is complete but is pending further verification in the system application vetting module 1011.

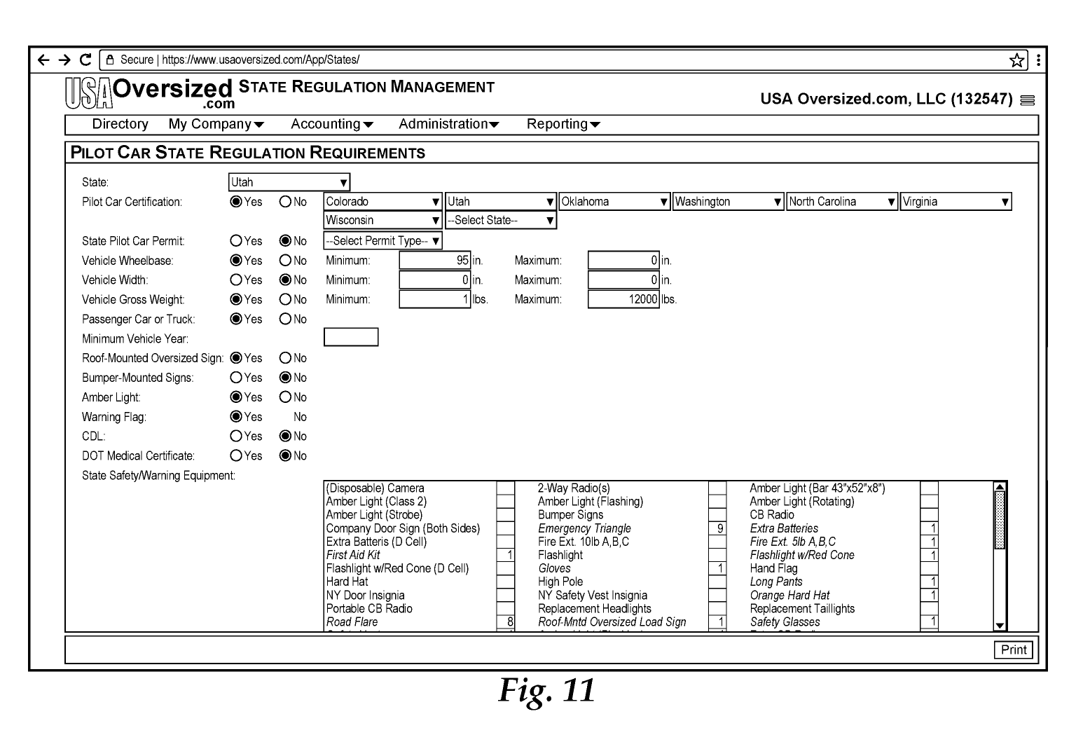

FIG. 11 is a screenshot of the state regulation audit module. This module provides input for a system administrator to add, modify, or remove regulation criteria for each state. The saved state regulation information is then used by the system to audit the registering pilot car company selected states of operation.

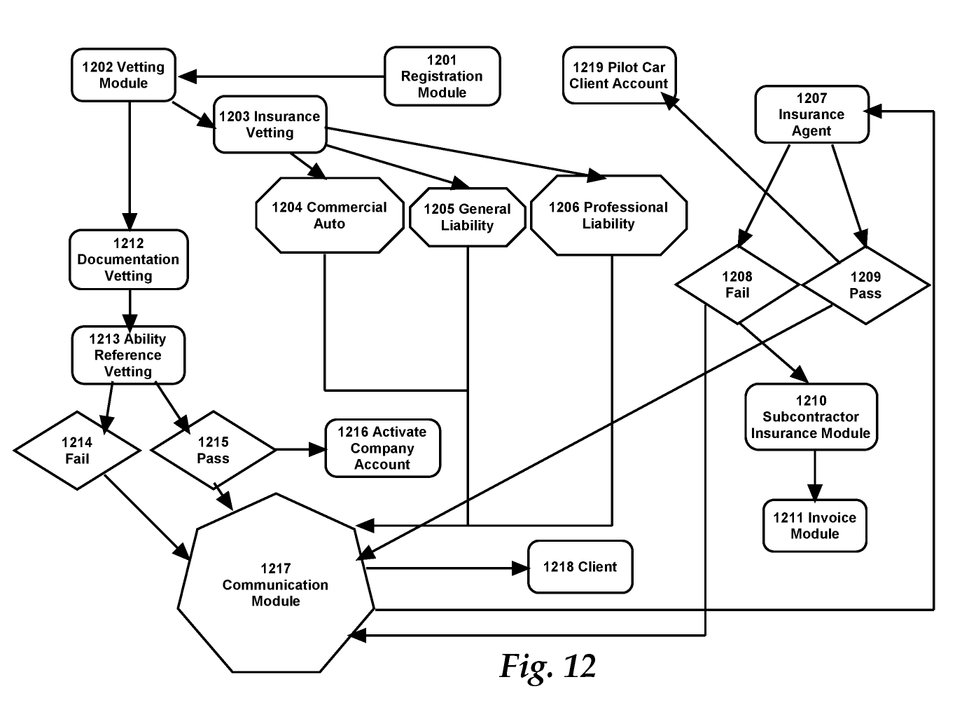

FIG. 12 is a flow diagram of the client vetting process. When a pilot car or dispatch company registration 1201 is completed and is passed to the vetting module 1202, an inactive and unverified account is created pending verification through the vetting module. Registered pilot car company accounts 1219 are vetted for insurance 1203 to verify commercial auto 1204, general liability 1205, and professional liability 1206 policies. If the pilot car company fails the automated vetting process, the vetting module composes an email message through the communication module with the insurance and other registration information and any uploaded insurance documents attached and sends the message to the outsourced insurance agent 1207. If the insurance vetting fails 1208 the outsourced insurance agent verification, the pilot car company may be activated and verified to become a subcontractor to be processed through the subcontractor insurance module 1210; in that event, insurance charges are deducted from the amounts paid to the subcontractor pilot car company via the invoicing module 1211. If the insurance vetting passes 1209 the outsourced insurance agent verification, the pilot car company is then activated and verified pending other vetting procedures.

Registered pilot car and dispatch company accounts are also vetted for adequate documentation 1212, and ability references 1213 are checked for registered pilot car accounts. Registered accounts that pass both the outsourced insurance agent verification and other vetting procedures are activated 1216 and verified. Email messages are composed of the vetting outcomes, including the pass 1215 or fail 1214 of the ability reference vetting, and are sent through the communication module 1217 to the registered pilot car and/or dispatch company account(s). Along with the email messages, the registered pilot car or dispatch company client 1218 may view any outstanding vetting results from the client browser.

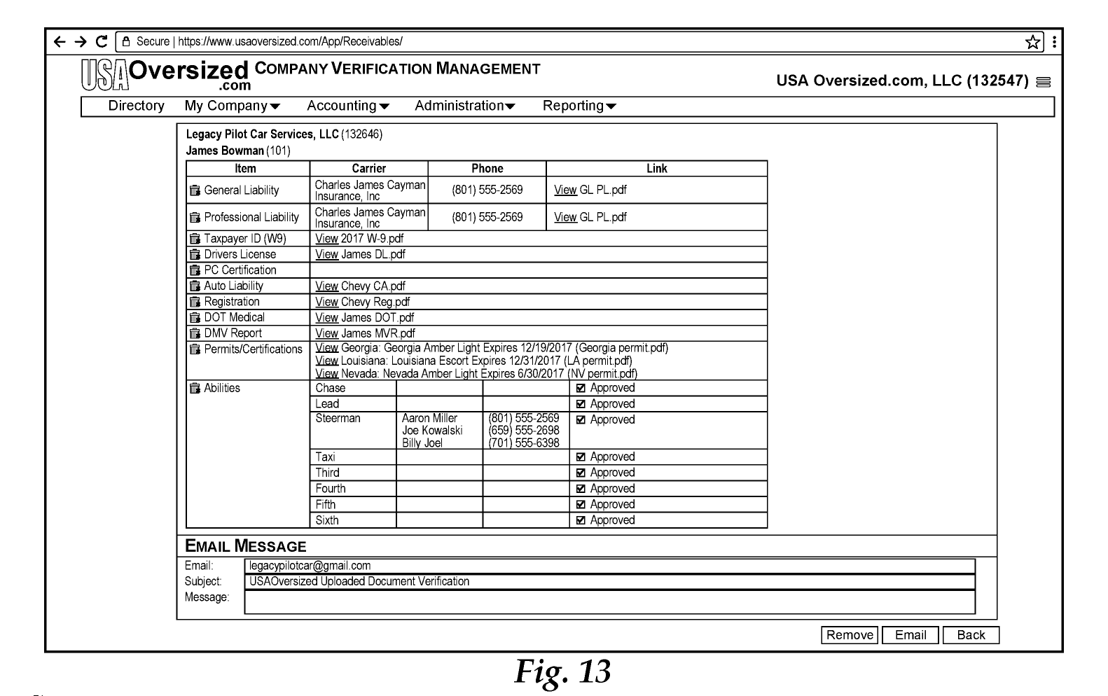

FIG. 13 is a screenshot of the client vetting module. A system administrator uses this module to view and verify uploaded documents, as well as to verify references and approve abilities. The registered company vetting module also allows a system administrator to compose an email message to the registering company with information regarding the state of the vetting process including the attachment of an ACH form to allow for direct deposit payments.

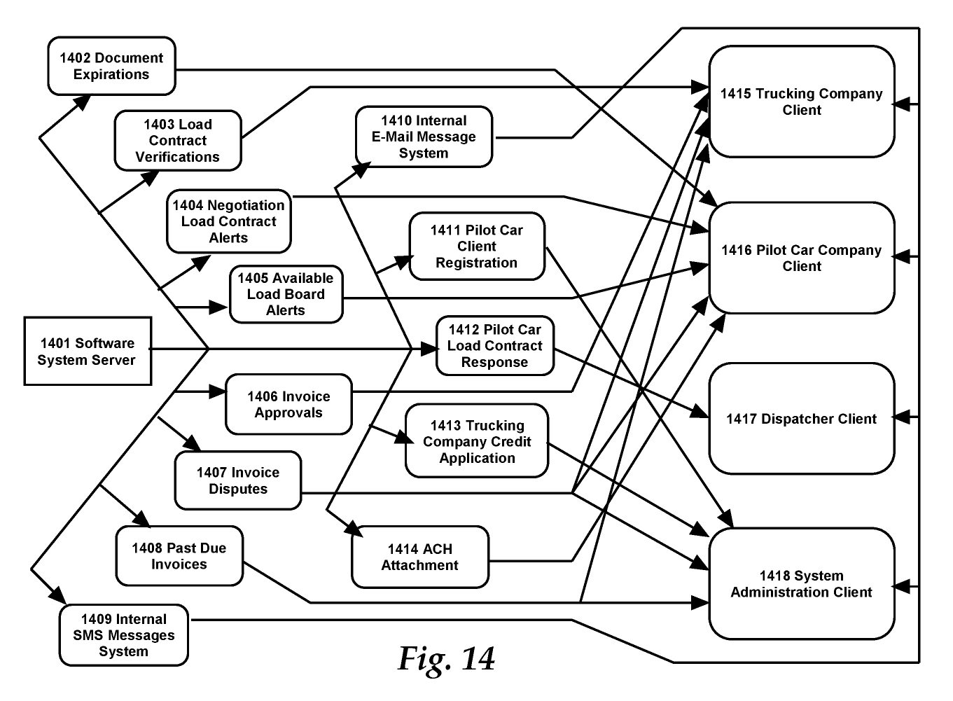

FIG. 14 is a flow diagram of the software communication system of the present invention. The compiled code on the server 1401 (also reference number 101 on FIG. 1) composes email messages of document expirations 1402 and sends them to pilot car accounts 1416, and it also sends load contract verifications 1403 to trucking company client accounts 1415, load contract rate offers 1404 to pilot car company accounts, new load board load contract alerts 1405 to all registered and available pilot car company accounts, invoice approvals 1406 to trucking company client accounts, invoice disputes 1407 to trucking company client and pilot car company accounts, past due invoices 1408 to trucking company client accounts, and internal messages 1409 to all accounts using the built-in software server email messaging system 1410.

The compiled code on the server composes email messages of new pilot car registrations 1411 and pilot car registration changes to the system administrator account 1418, pilot car load contract rate offer and load contract application responses 1412 to the dispatch company account 1417, new trucking company credit applications 1413 to the system administrator account 1418, and automated clearing house (ACH) attachment 1414 messages to pilot car company accounts 1416 and sends the messages using the built-in email messaging system. The built-in email messaging system is part of a framework set of classes and objects that interface with email servers for sending and receiving email messages.

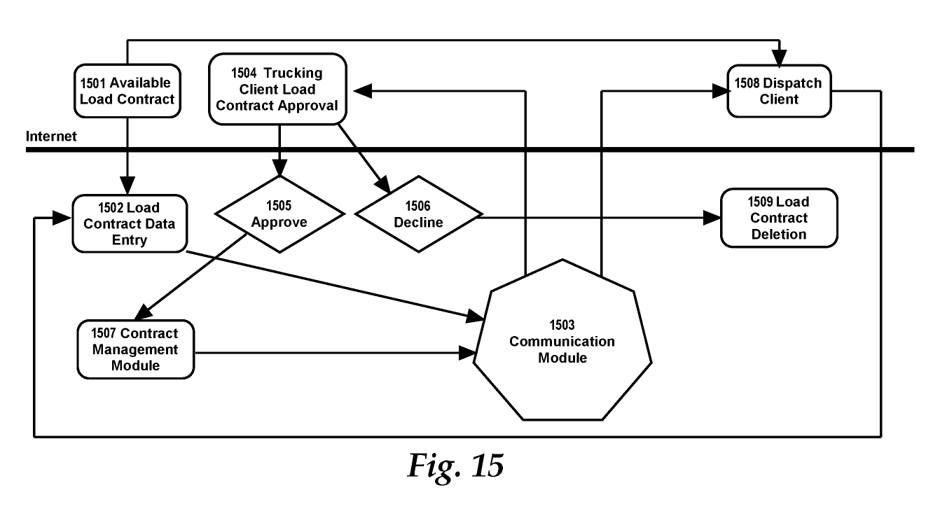

FIG. 15 is a flow diagram of the load contract data entry form. When a trucking company client provides an available load contract 1501, the receiving registered dispatch client 1508 enters the load data 1502 into the system. When the load contract information is saved, an email message is composed for requesting load contract approval 1504 and sent via the communication module 1503. If the trucking company client approves 1505 the load contract, it then becomes available in the load contract management module 1507. An email message is composed with the results of the load contract request and sent to the dispatch client via the communication module 1503. If the trucking company client declines the load contract 1506, it then is deleted 1509 from the database.

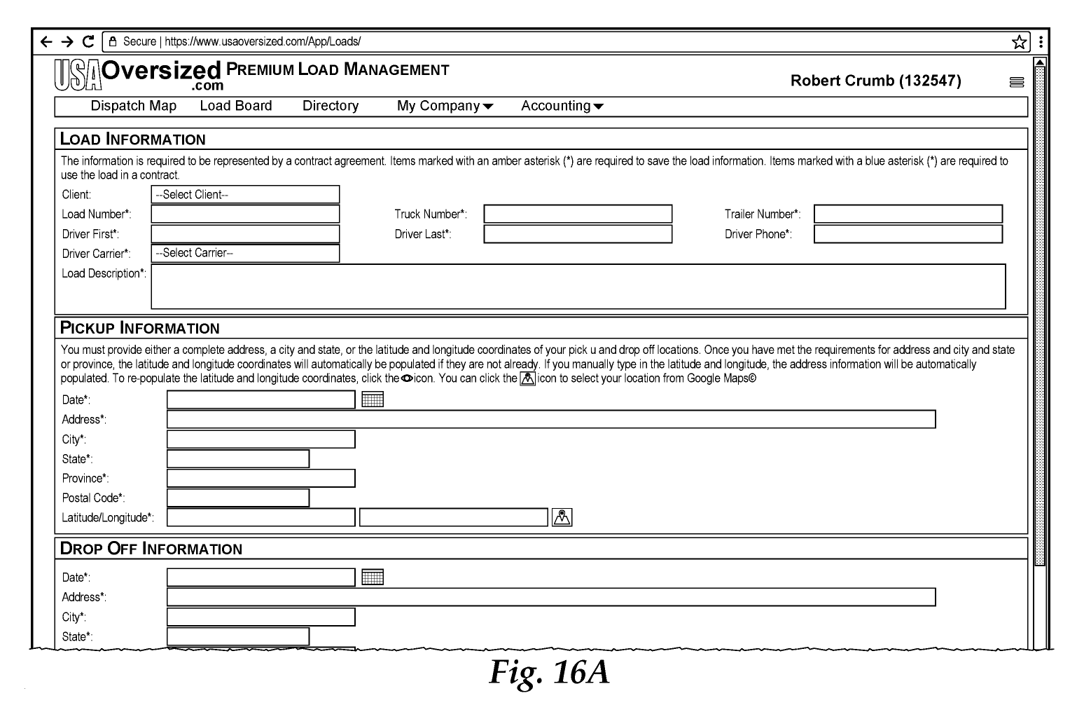

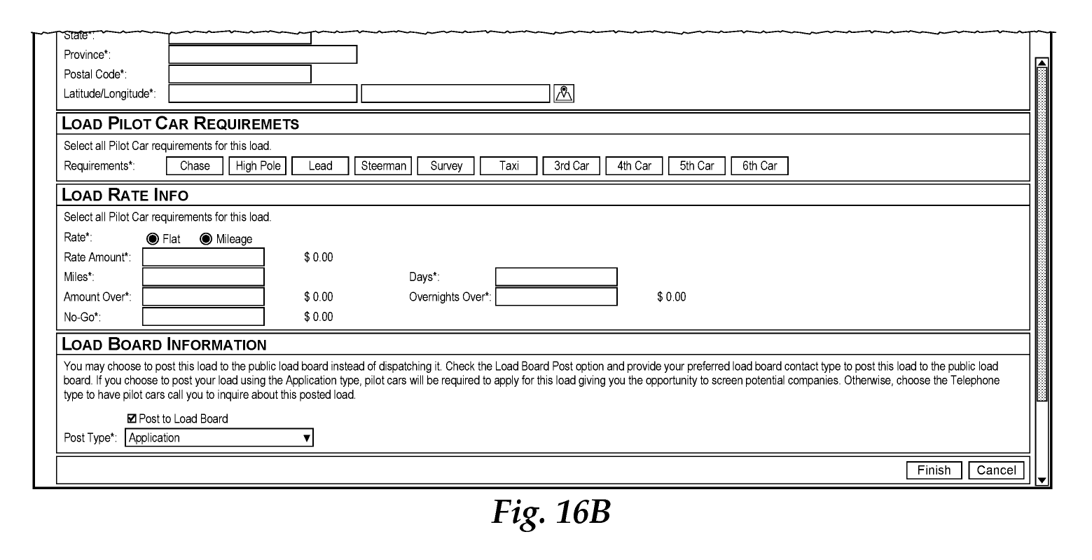

FIGS. 16A-168 are screenshots of the load contract detail section of the load contract management module. This module section provides a form for registered dispatch company administrators to provide or change the details of the load contract.

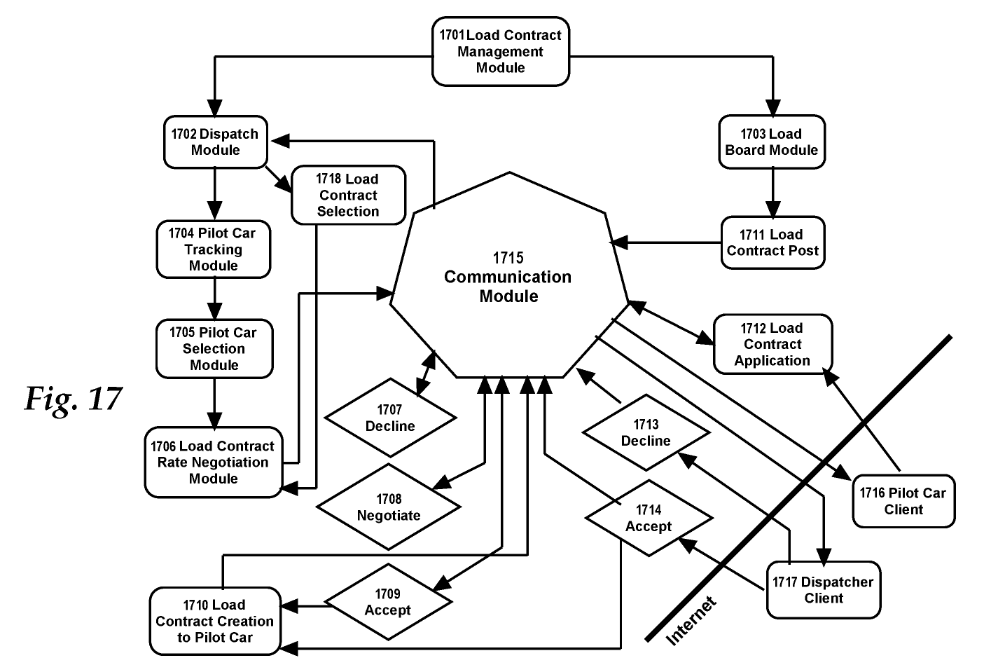

FIG. 17 is a flow diagram of the load contract management module. From the load contract management module 1701, an available load contract is assigned either to the load board module 1703 or to the dispatch module 1702. When a load contract is posted to the load board module, an email message with the details of the load contract post 1711 is composed and sent via the communication module 1715 to all registered pilot cars. The pilot car client 1716 then uses the software system to submit a load contract application 1712 to be reviewed later by the dispatch client 1717. The dispatch client reviews load contract applications and accepts 1714 one. All other load contract applications are then automatically declined 1713, and an email message is composed stating that the load contract is no longer available and sent via the communication module 1715 to declined pilot car companies. The accepted load contract application automatically creates a load contract with the applying pilot car 1710.

The dispatch module is comprised of an interactive map that uses the pilot car tracking module 1704 and available load contracts to perform load contract selection 1718 and the pilot car selection module 1705. The load contract rate negotiation module 1706 is used to make a load contract offer to the selected pilot cars. An email message is composed with the details of the load contract and load contract rates and sent via the communication module 1715 to the selected pilot cars. The selected pilot cars may then choose to either decline 1707, negotiate 1708, or accept 1709 the contract rate offer. The system composes email messages and uses the communication module 1715 to send the subsequent load contract rate negotiation information. When a load contract rate offer is accepted by a pilot car, an email message is composed stating that the contract rate offer is no longer available, the email message is sent via the communication module 1715 to all other contract rate offer recipients, and the system creates the load contract with the accepting pilot car (see reference number 1501 on FIG. 15).

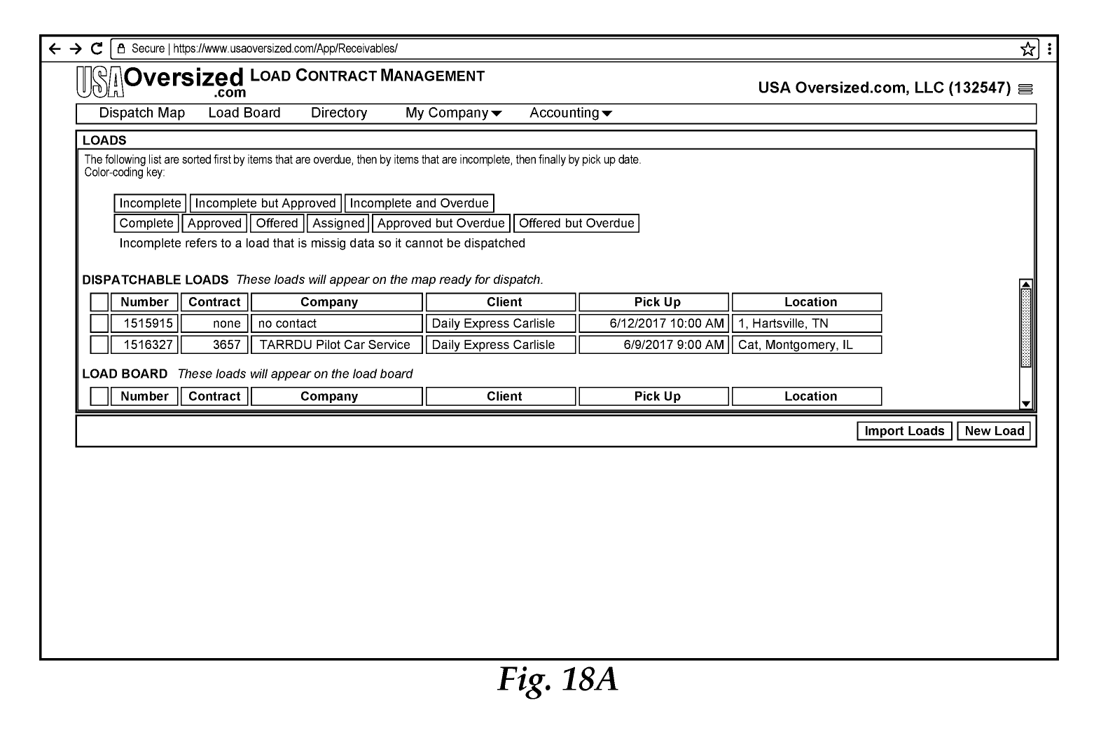

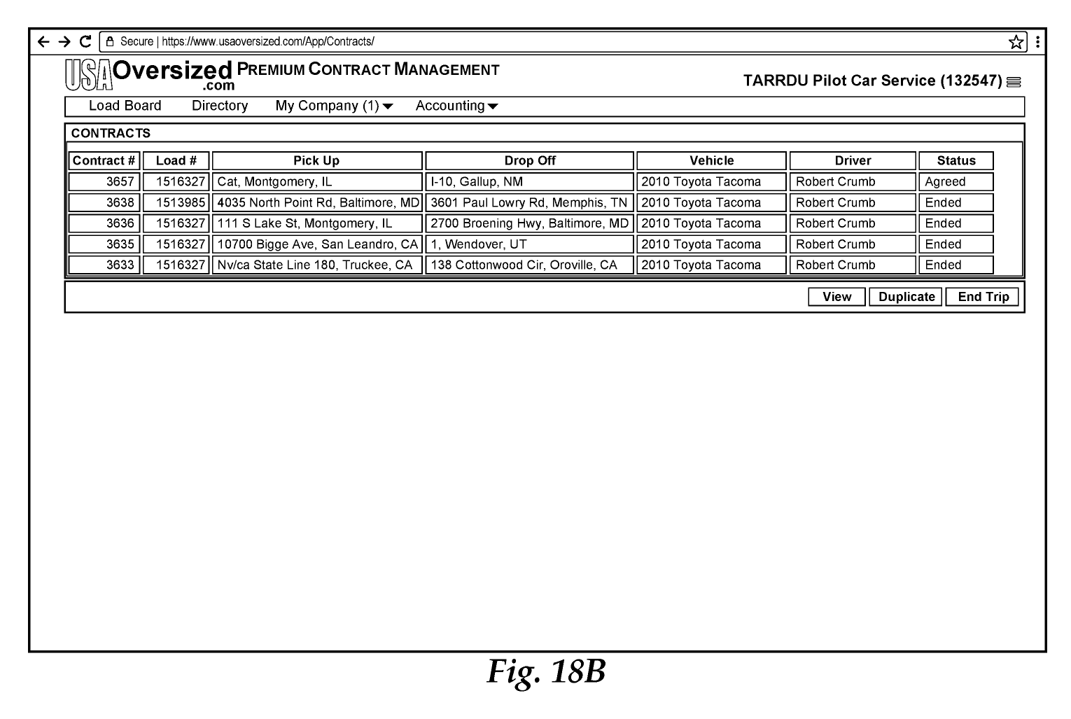

FIG. 18A is a screenshot of the load contract selection section of the load contract management module. This module section provides a list to the registered dispatch company administrator of all loads belong to that registered dispatch company. A registered dispatch company administrator can view the details of a load by clicking an item in the list.

FIG. 18B is a screenshot of the pilot car contract management module. From this screen, a pilot car company may view the details of a contract by selecting an item from the list. A pilot car may elect to end the contract by clicking the end trip button.

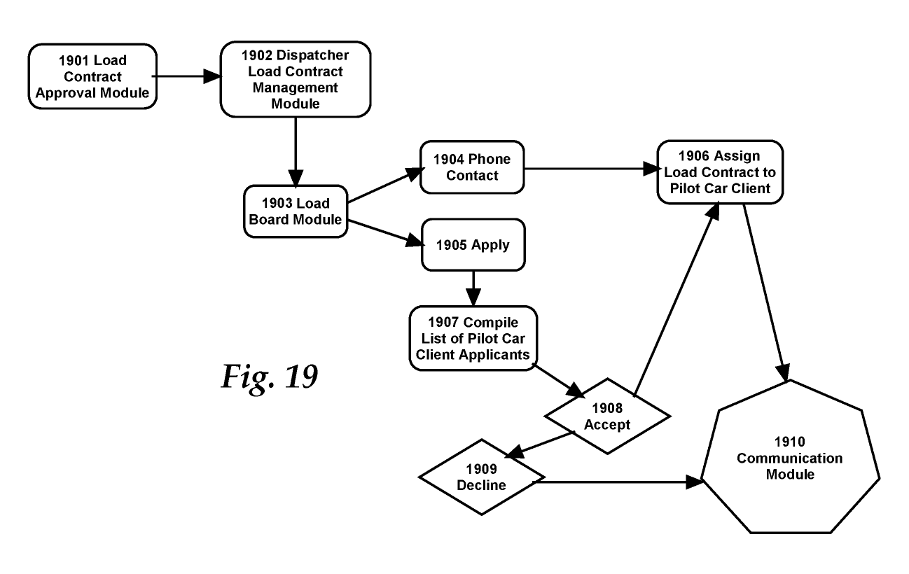

FIG. 19 is a flow diagram of the load board module. When an available load contract is approved in the load contract approval module 1901 (see FIG. 15) and made available in the dispatcher load contract management module 1902, it is then saved to the database and posted to the load board module 1904.

A contract load posted to the load board module is available to any registered pilot car. Depending on how the load contract was posted, the pilot car either may use the load contract post phone contact 1904 to call the posting dispatch company or may apply 1905 for the load contract via the client browser. When the load contract post is set to show a contact phone and the call is made, a load contract is then assigned to the calling pilot car 1906. An email message is composed stating that the posted load contract is no longer available and sent via the communication module 1910 to all registered pilot cars. When a pilot car applies for the posted load contract, the application information is saved to a list of pilot car client applications 1909 in the database. When a posted load contract application is accepted 1908 (see FIG. 17), the posted load contracted is then assigned to the applying pilot car. The system automatically declines 1909 all other posted load contract applications and composes an email message stating that the load is no longer available. The message is sent via the communication module 1910 to send the message to all registered pilot cars 1906.

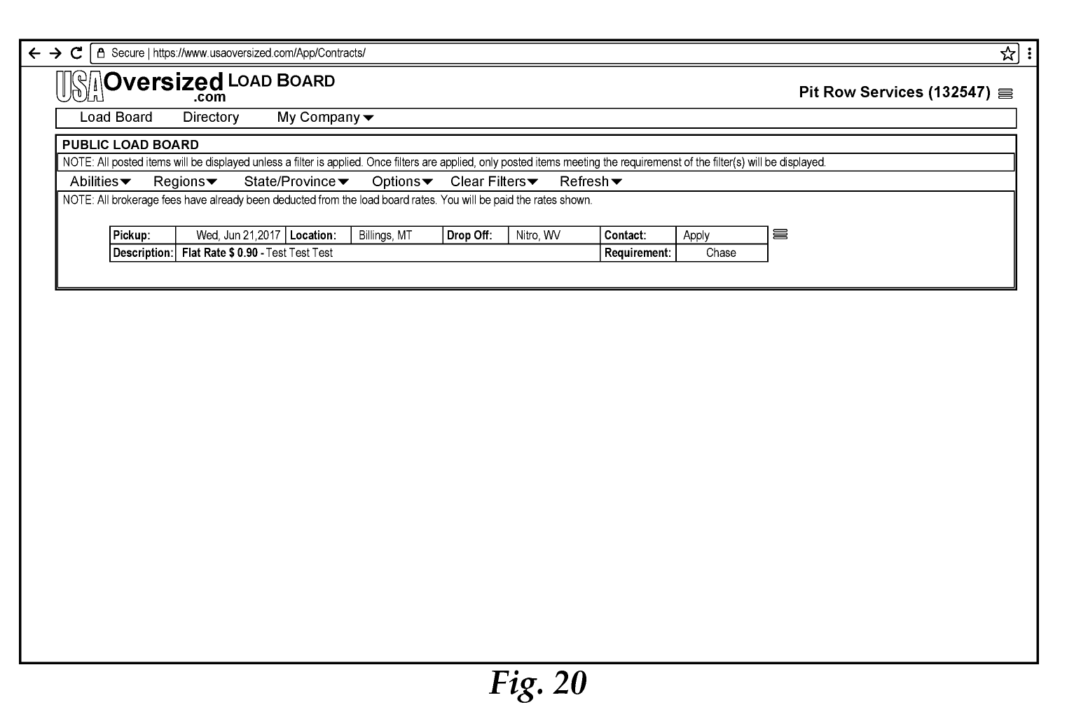

FIG. 20 is a screenshot of the load board module. This section displays a list of all available load contracts to qualified registered pilot car companies.

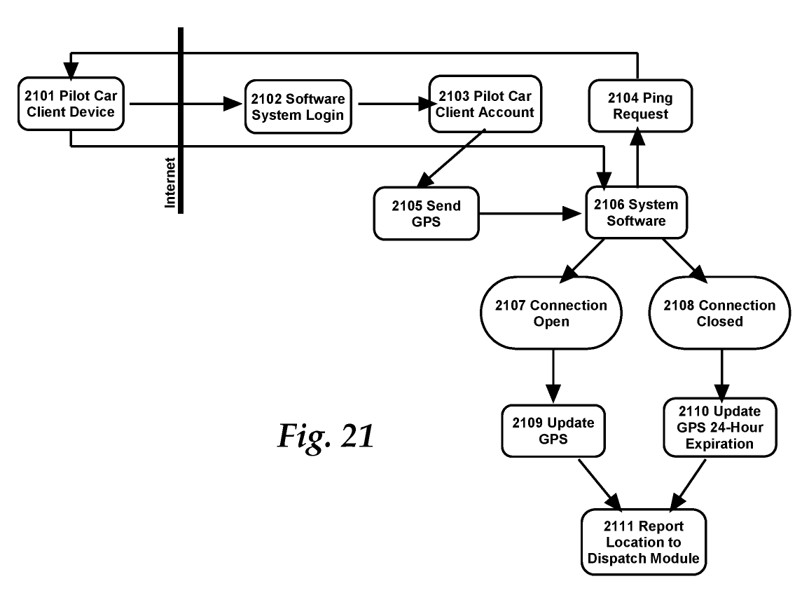

FIG. 21 is a flow diagram of the pilot car client tracking module. The first step in the pilot car tracking module occurs when the pilot car client 2101 uses the system login 2102 to gain access to the system. The pilot car client then uses the pilot car client account 2103 to send GPS 2105 location information to the system 2106. The system uses this process to determine if a timely connection 2107, 2108 (connection open or closed) has been made to update GPS location information 2109. The updated GPS location information is then used to report the location of the pilot car to the dispatch module 2111. GPS location information automatically expires 24 hours after the update 2110.

The second step in the pilot car tracking module occurs when the system 2106 sends a ping request 2104 notification to the pilot car client mobile device 2101. The pilot car client mobile device responds to the ping request notification by using the system login to gain access.

The compiled code on the pilot car mobile device is set to remain in a logged in state and listens for incoming ping request notifications. When the compiled code receives an incoming ping request notification, it then captures the mobile device GPS location information and sends the data to the server. Compiled code on the server listens for incoming GPS location update information from the pilot car client mobile device. When GPS location update information is received, a new GPS location record is added to the database along with the date and time of the update. The date and time of the update are used to determine the expiration of the GPS location information. The available pilot car selection procedure on the database filters the selection by GPS location information that was updated within a twenty-four hour period.

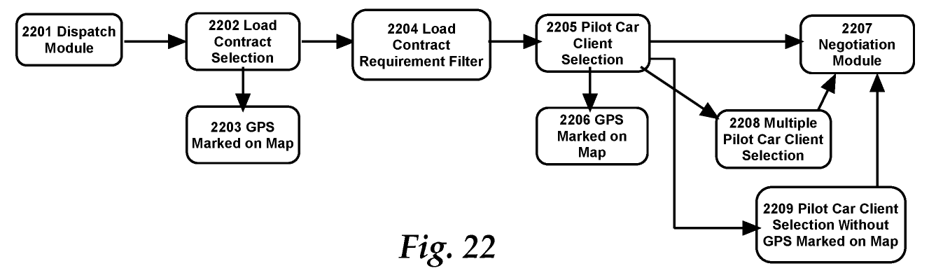

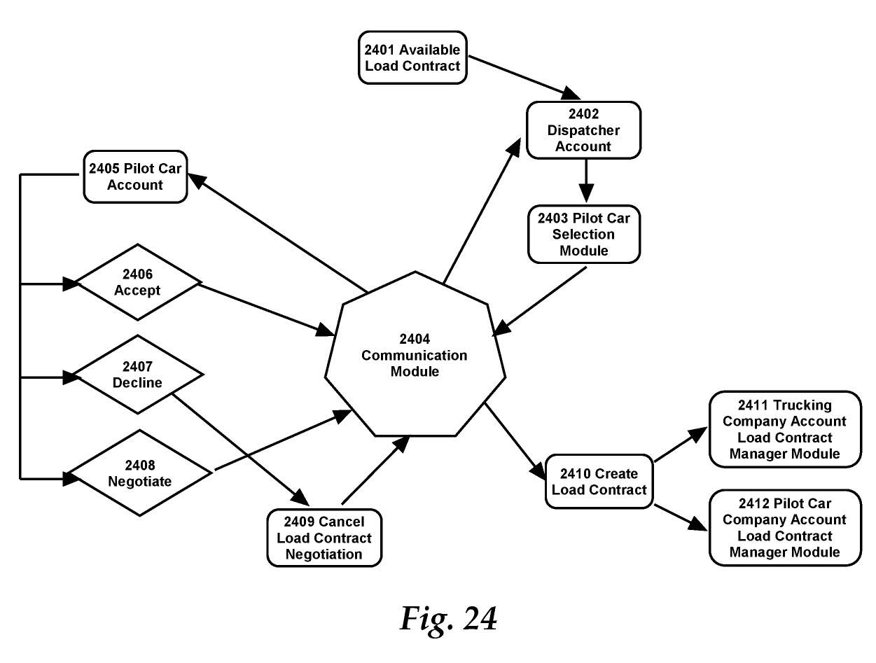

FIG. 22 is a flow diagram of the pilot car selection module. The dispatch module 2201 uses the load contract selection 2202 process to select a load contract that is placed on an interactive map using the GPS location of the load contract 2203. The available pilot cars then go through a load contract requirement filter 2204 to show only those pilot cars that qualify for the load contract. The dispatch module then uses the pilot car selection 2205 process to select pilot cars that are placed on the interactive map using their updated GPS location information 2206. The dispatch module uses a pilot car client selection without GPS location information 2209 to select available pilot cars that do not have updated GPS location information. The dispatch module uses the pilot car selection process to select one or multiple pilot car clients 2208 to initiate a load contract rate offer 2207 (see FIG. 24).

Scripting code on the dispatch client browser synchronously sends load contract selection information to the server to request an update of filtered pilot cars. The compiled code on the server receives the filtered selection request and returns only the list of pilot cars meeting the selection filter criteria.

Scripting code on the dispatch client browser synchronously sends a request to the server requesting a list of pilot cars without GPS location information. Compiled code on the server receives the request and returns only the list of pilot cars that do not have updated GPS location information.

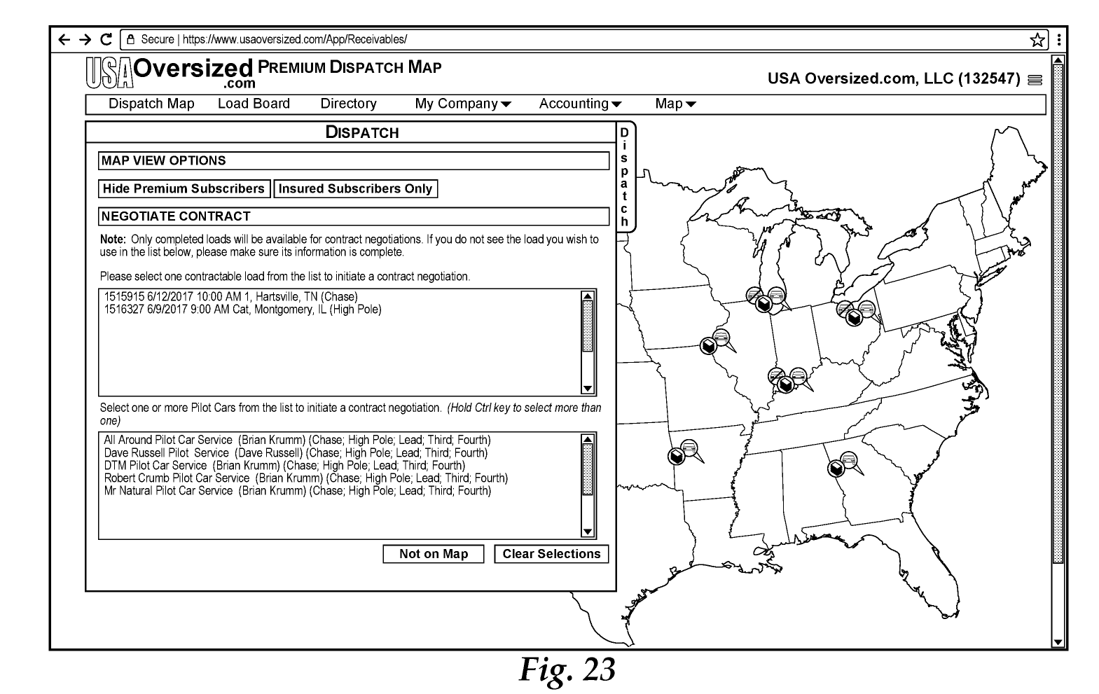

FIG. 23 is a screenshot of the dispatch management module. This module displays a graphic-based interactive map solution for the selection of pilot car companies and available load contracts. The graphical interactive map is displayed with icons placed according to the GPS location of all qualified pilot car companies, as well as the registered dispatch company available load contracts. This module also provides a dynamic slide-out feature for the text-based solution for the selection of pilot car companies and available load contracts.

FIG. 24 is a flow diagram of the load contract negotiation module. Starting with a selected available load contract 2401 entered by the dispatch account 2402, the pilot car selection module 2403 (see FIG. 22) is used to initiate a contract rate negotiation. An email message with the contract rate offer information is composed and sent via the communication module 2404 to the selected pilot cars. The selected pilot car account 2405 receives the contract rate offer and may either accept 2406, negotiate 2408, or decline 2407 the load contract rate offer. When the load contract offer is declined, the load contract offer and all subsequent negotiations are cancelled 2409 and deleted from the database for that pilot car. During the contract rate offer negotiation process, email messages are composed of subsequent negotiation information, and the communication module is used to send the messages. When a load contract rate offer is accepted by a pilot car, a load contract between the trucking company/dispatcher and pilot car is created 2410 and becomes available to the trucking company/dispatch company account load contract manager module 2411 and the pilot car company account load contract manager module 2412.

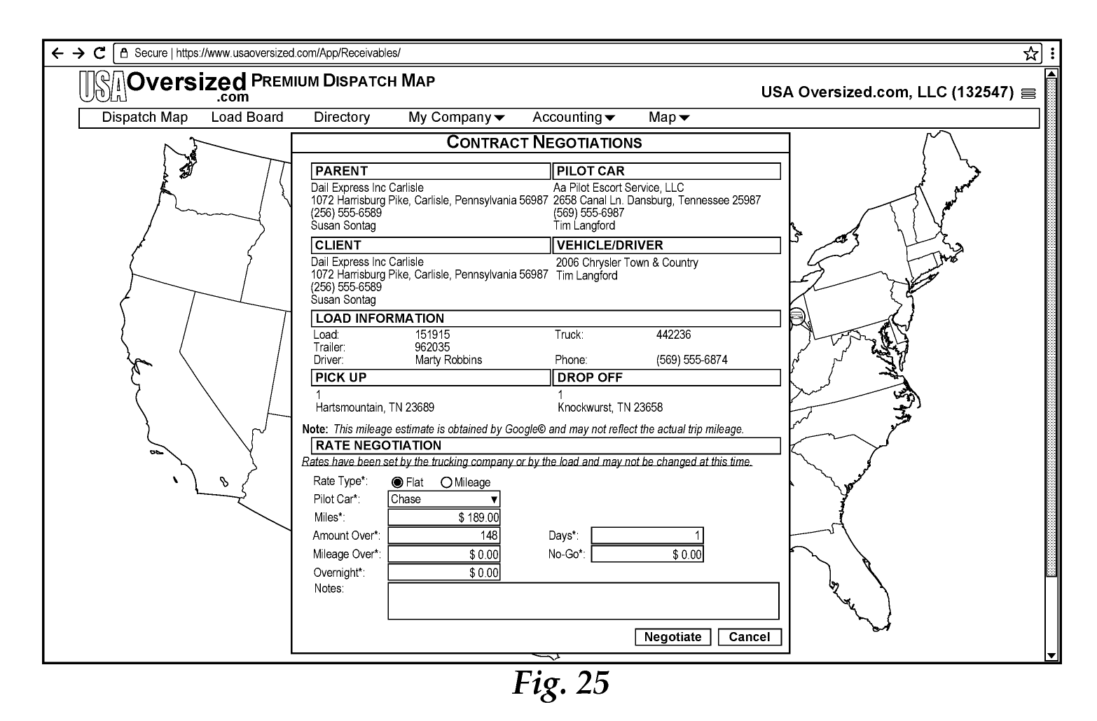

FIG. 25 is a screenshot of the load contract negotiation module. This module is provided upon the selection of an available load contract and one or more qualified pilot car companies. The load contract negotiation module allows the registered dispatch company to engage in the negotiation of a contract with the qualified pilot car companies for the escort of the selected load contract.

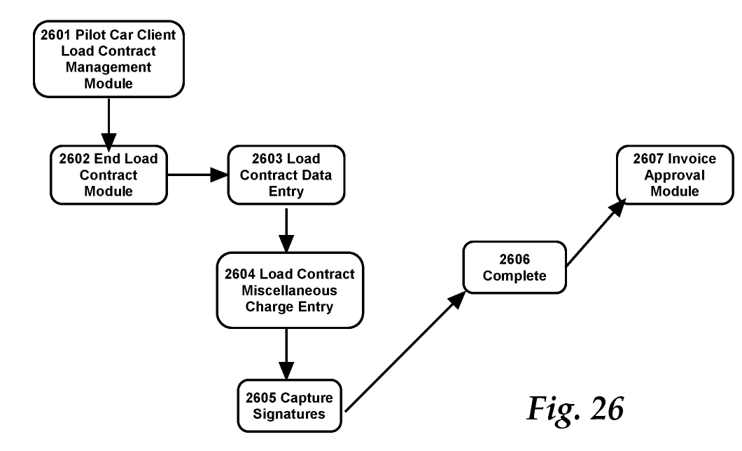

FIG. 26 is a flow diagram of the end load contract module. When the terms of the load contract have been satisfied, the pilot car uses the pilot car client load contract management module 2601 to initiate the end of the load contract. The pilot car uses the end load contract module 2602 to provide load contract trip data 2603, any load contract trip miscellaneous charges 2604, and graphical signatures 2605 to complete 2606 the load contract. When the load contract trip is ended, a procedure on the database automatically creates all pertinent invoices. Invoices then go through the invoice approval module 2607 to be approved by the load contract trucking company client.

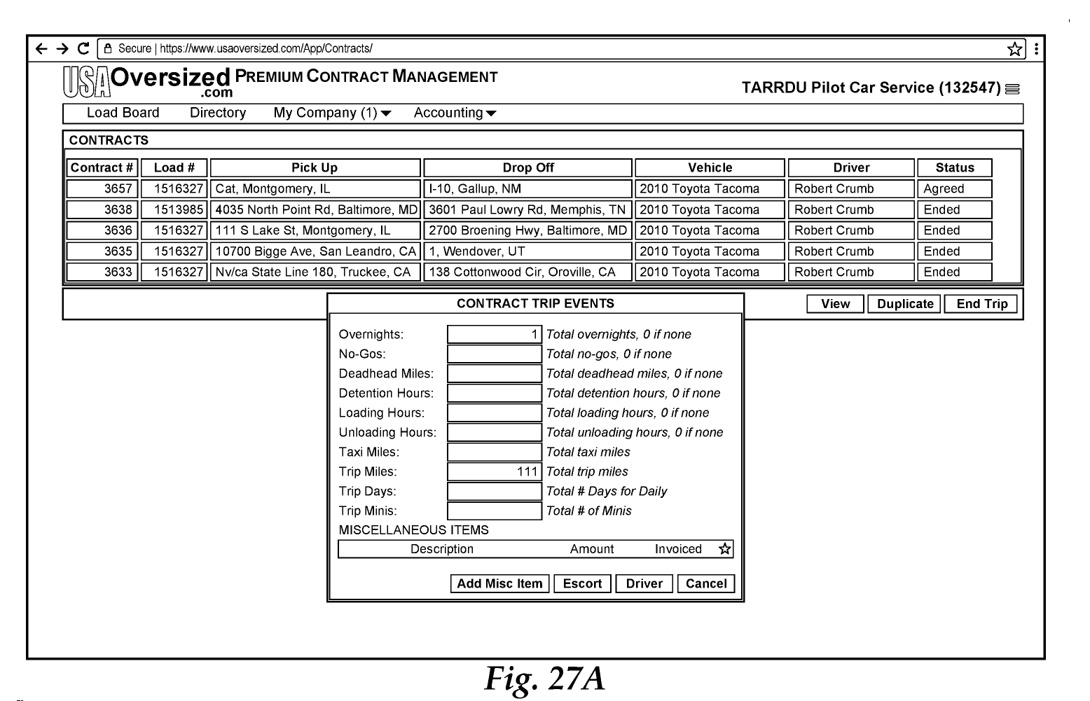

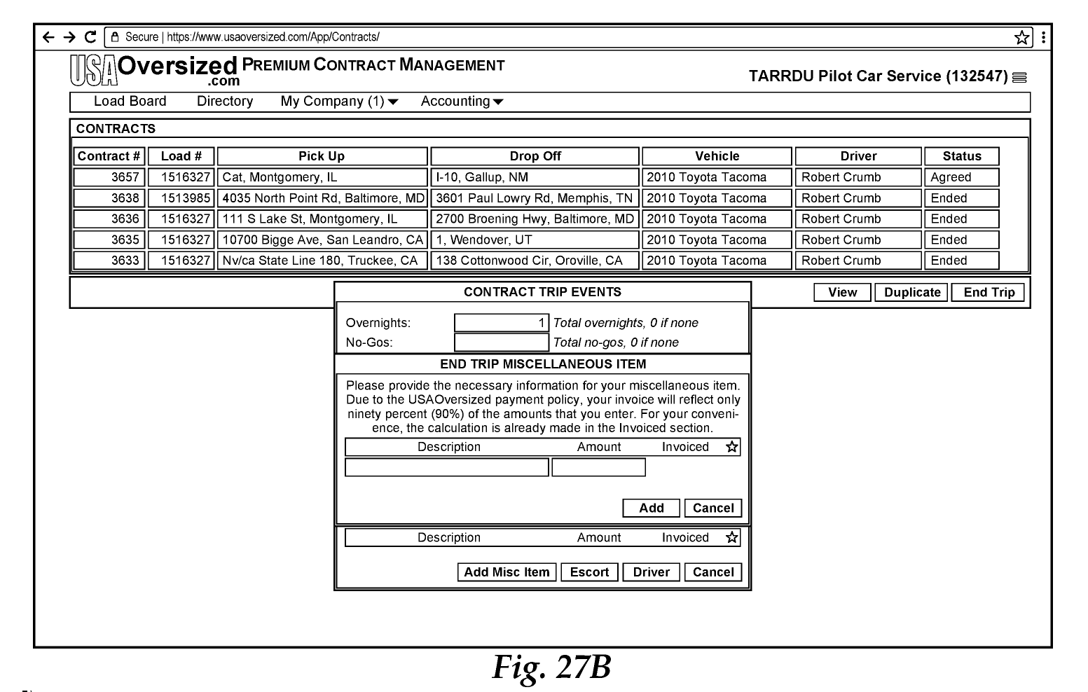

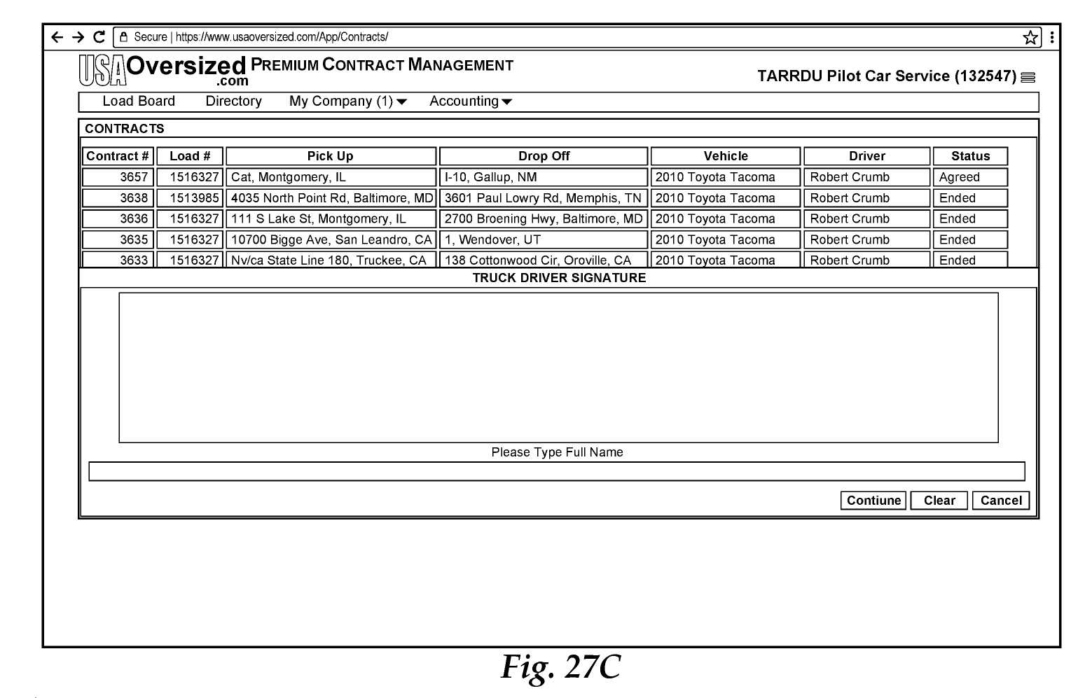

FIGS. 27A-27C are screenshots of the end load contract section of the pilot car contract management module. This section provides a form for a contracted pilot car company to enter the details of the escort contract, any additional trip event information (see FIG. 27B), as well as an area for signatures (see FIG. 27C) by both the pilot car company driver and the trucking company client driver.

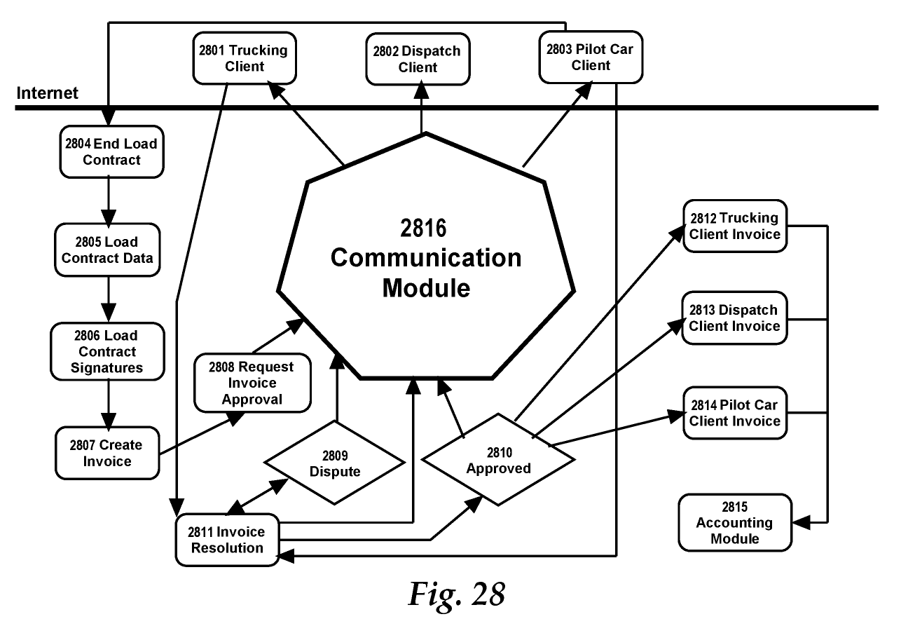

FIG. 28 is a flow diagram of the invoicing module. When a load contract trip has been ended 2804 (see FIG. 26), the pilot car has provided load contract trip data 2805, and captured graphical signatures 2806 have been saved to the software system database, a trucking company client invoice 2812, a dispatch client invoice 2813, and a pilot car invoice 2814 are created 2807. An email message is then composed of the invoice information with a request for invoice approval 2808 and sent via the communication module 2816. The trucking company client invoice reflects charges from the broker to the trucking company, the dispatch client invoice reflects charges from the dispatch client to the broker, and the pilot car invoice reflects charges from the pilot car company to the broker. As used herein, the term “broker” means the system administrator.

The trucking company client 2801 receives the invoice approval request and uses invoice resolution 2811 to either dispute 2809 or approve 2810 the invoice. An email message is composed of the dispute or approve response and sent via the communication module 2816 to the pilot car company. Until the dispute has been resolved, email messages are composed of the details of the dispute, and the communication module is used to send the messages to both the trucking company client and the pilot car company client. When the trucking company client approves the invoice, it is then available in the accounting module 2815. The trucking company client, the dispatch client 2802, and the pilot car client 2803 may then use the accounting module to view their invoices.

When the procedure is called on the database to create the invoices, the system first obtains the default rates of the trucking company client, any override rates of the load contract, and the negotiated rates between the dispatch account and the pilot car account. If the pilot car account was made a subcontractor (as described above in connection with FIG. 12), additional invoices are created to reflect the subcontractor insurance agreement.

The system uses the negotiated rates between the dispatch account and the pilot car account to generate the first invoice for the pilot car account that is billed to the administrator account. If the pilot car has been established as a subcontractor, an invoice is generated for the subcontractor pilot car account and billed to a separate business entity that maintains its own insurance coverage for the subcontracted pilot car (this separate business entity may or may not be under common ownership with the broker/system administrator) including the insurance deduction amounts. Another invoice is then generated (using the same negotiated rates) from this separate business entity and billed to the administrator account without the insurance deductions.

Next, the system uses the trucking company client default rates or the trucking company client load contract override rates to generate an invoice for the dispatch account billed to the administrator account for a fixed percent.

Finally, the system uses the trucking company client default rates or the trucking company client load contract override rates to generate an invoice for the administrator account billed to the trucking company client.

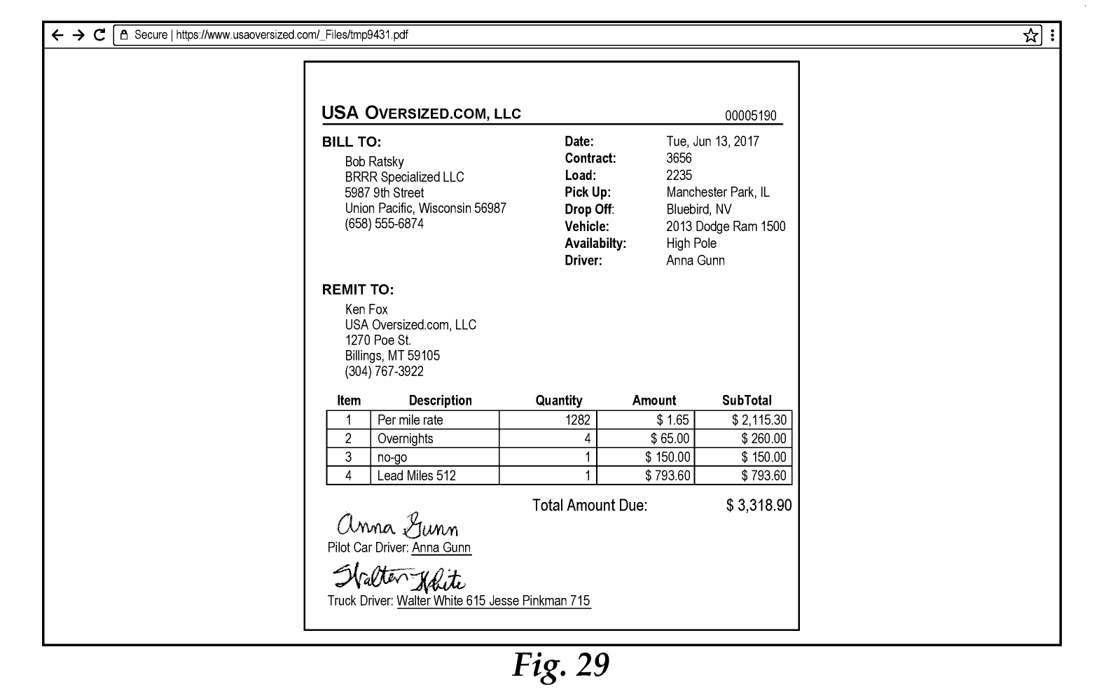

FIG. 29 is a screenshot of a dynamically created contract invoice. Contract invoices are generated using the pilot car driver submitted escort trip information along with the negotiated rate information of the contract.

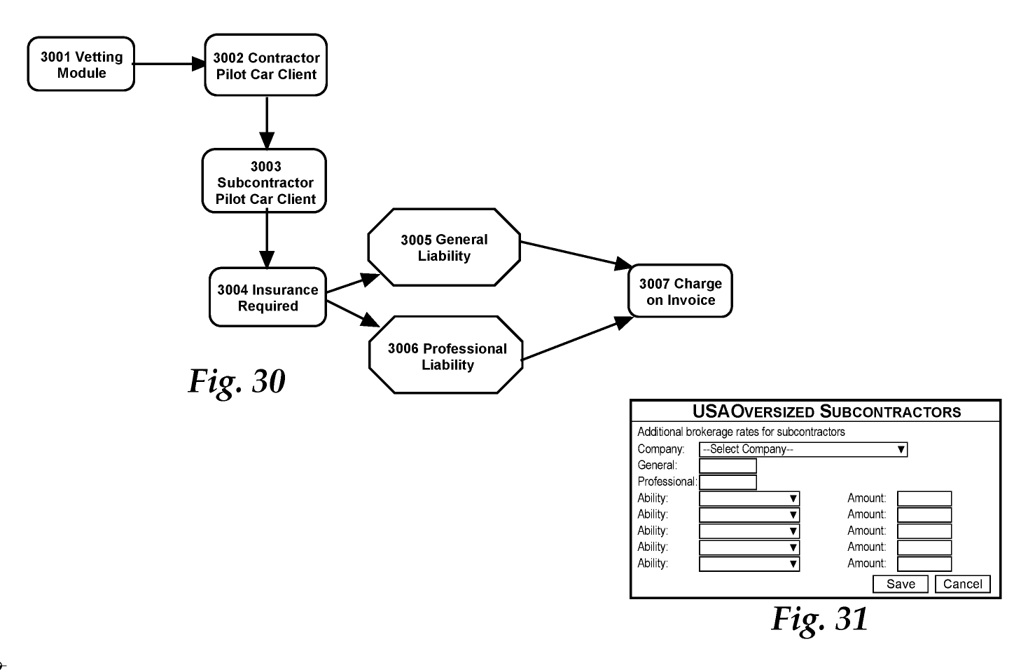

FIG. 30 is the flow diagram of the subcontractor pilot car client insurance module. When the vetting module 3001 fails to validate the pilot car general liability or professional liability insurance (see FIG. 12), the contractor pilot car client 3002 (this is the separate business entity referred to in the preceding discussion of FIG. 28) then has the option to make the failed pilot car a subcontractor pilot car client 3003. Procedures on the software system database then determine the insurance requirements 3004 of the pilot car for general liability 3005 and professional liability 3006 and add additional charges to the pilot car invoice 3007.

FIG. 31 is a screenshot of the subcontractor pilot car client insurance module. The information provided in this module will determine the invoice insurance deductions for pilot car companies that are designated as subcontractors.

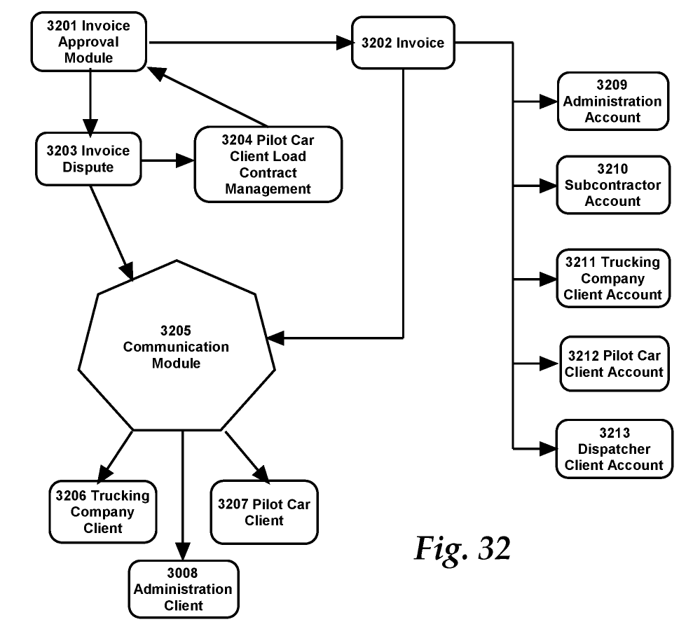

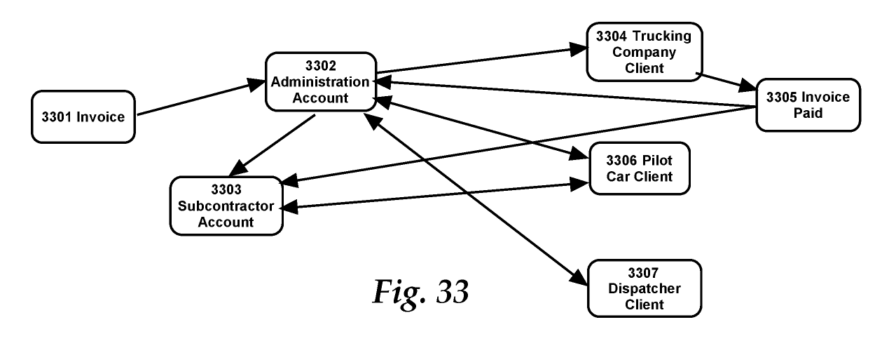

FIG. 32 is a flow diagram of the invoice approval/dispute module. The invoice approval/dispute module 3201 is used either to approve or to dispute 3203 an invoice 3202 between the trucking company client and the pilot car client through pilot car client load contract management 3204. During the dispute process, email messages are composed with the details of the dispute, and the communication module 3205 is used to send the messages between the trucking company client 3206, the pilot car client 3207, and the administration client 3208 for invoice dispute monitoring. When the invoice dispute is resolved, the invoice is then made available to the administration account 3209, the subcontractor account 3210, the trucking company client account 3211, the pilot car client account 3212, and the dispatch client account 3213.

FIG. 33 is a flow diagram of the accounting module. When a load contract trip is ended, an invoice 3301 is created for the administration account 3302 and billed to the trucking company client 3204. An invoice is created for the subcontractor account 3303 and billed to the contractor pilot car client 3306. An invoice is created for the dispatcher client 3307 and billed to the administration account. The administration account is responsible for accepting payment and updating invoice paid 3305 information.

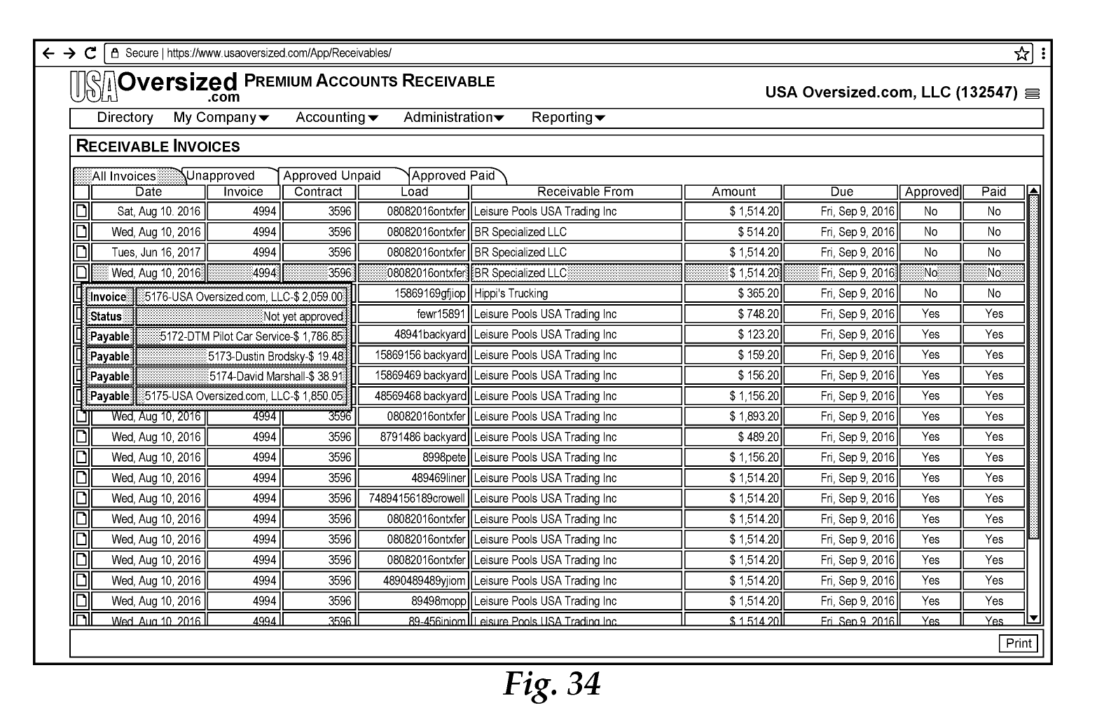

FIG. 34 is a screenshot of the invoice management module. This module shows a list of all contract invoices.

Although the preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

We claim:

1. A computer-implemented system for managing pilot car escorts for oversized cargo ground shipping comprising:
(a) one or more servers upon which are hosted:
(i) a registration module that is configured to accept registrations by trucking companies, pilot car companies, and dispatch companies;
(ii) a pilot car audit module that is configured to determine via an automated audit process whether state regulatory requirements are met by a pilot car company for selected states of operation; and
(iii) a vetting module that is configured to determine via an automated vetting process whether the pilot car company possesses commercial auto insurance, general liability insurance, and professional liability insurance;
(b) a pilot car client computer that is configured to provide access to a browser, wherein the pilot car client computer synchronously sends pilot car registration information to the server to initiate the automated audit process, and wherein the server synchronously returns audit results to the pilot car client computer;
(c) a dispatch client computer that is configured to provide access to a browser, wherein the dispatch client computer synchronously sends load contract selection information to the server, and wherein the server synchronously returns to the dispatch client computer a list of pilot cars that meet selection filter criteria; and
(d) a pilot car mobile device that is configured to enable tracking of pilot cars by the system.

2. The system of claim 2, wherein the one or more servers are further configured to host a load contract management module;
wherein the load contract management module is configured to assign available load contracts to a load board module or a dispatch module;
wherein the system is configured to send email notifications to all registered pilot cars when an available load contract is posted to the load board module;
wherein the system is configured to enable a pilot car client to submit a load contract application;
wherein the system is further configured to enable a dispatch client to review and accept or decline the load contract application;
wherein the system is configured to create automatically a load contract between the dispatch client and an accepted pilot car client; and
wherein the system is configured to enable a trucking company client to accept or decline the load contract.

3. The system of claim 2, wherein the one or more servers are further configured to host a pilot car contract management module; and
wherein the pilot car contract management module is configured to enable a pilot car company to view details of the load contract and to end the load contract.

4. The system of claim 3, wherein the one or more servers are further configured to host an end load contract module;
wherein the end load contract module is configured to enable the pilot car client to provide load contract trip data, load contract trip miscellaneous charges, and graphical signatures for the load contract; and
wherein the system further comprises a database that creates automatically a trucking company invoice upon completion of the load contract and sends the trucking company invoice to an invoice approval module.

5. The system of claim 4, wherein the invoice approval module is configured to enable the trucking company client to approve or disapprove the trucking company invoice and to send the trucking company invoice to an invoice dispute module if the trucking company invoice is disapproved by the trucking company client.

6. The system of claim 4, wherein the database also creates a dispatch client invoice that reflects charges from the dispatch client to a system administrator and a pilot car client invoice that reflects charges from the pilot car client to the system administrator; and
wherein the system is configured to pay automatically the dispatch client invoice and the pilot car client invoice.

7. The system of claim 4, wherein the dispatch module is configured to select a load contract and to generate an interactive map using pilot car tracking information to display only those pilot cars that qualify for the load contract; and
wherein the dispatch module is configured to initiate a load contract offer to one or more qualified pilot car clients.

8. The system of claim 1, wherein the one or more servers are further configured to host a subcontractor pilot car client insurance module;
wherein when a pilot car company fails the vetting module, the system is configured to enable the failed pilot car company to be treated as a subcontractor pilot car via the subcontractor pilot car client insurance module.

9. The system of claim 1, wherein the one or more servers are further configured to host an additional pilot car client qualifications module;
wherein the additional pilot car client qualifications module is configured to enable a trucking company client to enter additional pilot car qualifications; and
wherein the additional pilot car client qualifications module filters registered pilot car companies against the additional pilot car qualifications entered by the trucking company and removes non-qualifying pilot car companies from pilot car selection.

10. The system of claim 1, wherein the server is configured to send email messages of document expirations to pilot car accounts, load contract verifications to trucking company client accounts, load contract rate offers to pilot car company accounts, load board load contract alerts to registered and available pilot car company accounts, invoice approvals to trucking company client accounts, invoice disputes to trucking company client and pilot car company accounts, and past due invoices to trucking company client accounts.
